(19) United States
(12) Patent Application Publication
(10) Pub. No.: US 2016/0092149 A1
(43) Pub. Date: Mar. 31, 2016

(54) PORTABLE INFORMATION DEVICE, IMAGE PROCESSING SYSTEM, REMOTE OPERATION METHOD, AND NON-TRANSITORY COMPUTER-READABLE RECORDING MEDIUM ENCODED WITH REMOTE OPERATION PROGRAM

(71) Applicant: KONICA MINOLTA, INC., Tokyo (JP)

(72) Inventor: Nobuhiro NOJIMA, Amagasaki-shi (JP)

(73) Assignee: KONICA MINOLTA, INC., Tokyo (JP)

(21) Appl. No.: 14/860,759

(22) Filed: Sep. 22, 2015

(30) Foreign Application Priority Data
Sep. 29, 2014 (JP) 2014-199281

(51) Int. Cl. G06F 3/12; H04N 1/00

(52) U.S. Cl. CPC G06F 3/1296; G06F 3/1294; G06F 3/1292; H04N 1/00307; H04N 2201/006

(57) ABSTRACT

A portable information device includes a controller. The controller executes: a pre-setting acquisition step of acquiring device identification information for identifying an image processing apparatus to execute a job and a unique setting value that is a setting value preset in the image processing apparatus; a setting step of setting a setting value; a job generation step of generating a job based on the set setting value; and a job transmission step of transmitting the generated job to the image processing apparatus specified by the device identification information acquired in the pre-setting acquisition step. The setting step includes an initial setting step of setting the acquired unique setting value in response to the unique setting value being acquired in the pre-setting acquisition step.

This application is based on Japanese Patent Application No. 2014-199281 filed with Japan Patent Office on Sep. 29, 2014, the entire content of which is hereby incorporated by reference.

### BACKGROUND OF THE INVENTION

1. Field of the Invention

The present invention relates to a portable information device, an image processing system, a remote operation method, and a non-transitory computer-readable recording medium encoded with a remote operation program. More specifically, the present invention relates to a portable information device capable of remotely controlling an image processing apparatus, an image processing system including the portable information device and the image processing apparatus, a remote operation method performed in the portable information device, and a non-transitory computer-readable recording medium encoded with a remote operation program.

2. Description of the Related Art

Recent portable information devices typified by smartphones have the function of communicating using the NFC (near-field wireless communication) system. A technique is known that allows an NFC-supporting device to perform a variety of processes by bringing a smartphone closer to the device.

For example, Japanese Patent Laid-Open No. 2014-090238 describes an image processing system including a first communication device and a second communication device that communicates with the first communication device. The first communication device includes a first near-field communication portion that performs wireless communication in accordance with a first communication system and a first far-field communication unit that performs wireless communication in accordance with a second communication system in which a communication distance is longer than the first communication system. The second communication device includes a second near-field communication unit that performs wireless communication in accordance with the first communication system and a second far-field communication unit that performs wireless communication in accordance with the second communication system. If near-field communication that is wireless communication in accordance with the first communication system is established between the first communication device and the second communication device in a state in which a condition for executing a job to be executed by one of the first communication device and the second communication device is satisfied, the image processing system performs: an advance communication process of passing connection information used for establishing far-field communication that is wireless communication in accordance with the second communication system and particular information obtained from the first communication device, between the first communication device and the second communication device; an advance start process of starting at least part of a process for completing the job after the particular information is passed; an establishing process of establishing the far-field communication between the first communication device and the second communication device using the connection information after the connection information is passed; and a subsequent communication process of passing image data based on the job between the first communication device and the second communication device via the far-field communication.

Some of the functions of an image processing apparatus are restricted in some cases. For example, when high-cost color printing is prohibited, a plurality of pages are aggregated on one sheet of paper in order to reduce the number of prints. This restriction is set in an image processing apparatus by the administrator who manages the image processing apparatus. When the image processing apparatus is remotely operated with a portable information device, the same restrictions as the restrictions set in the image processing apparatus are not imposed on the portable information device. If the process executed by the image processing apparatus by the portable information device remotely operating the image processing apparatus is a process restricted in the image processing apparatus, the image processing apparatus is unable to execute the process. The same restrictions imposed on the image processing apparatus may be set in the portable information device, but if so, the same restrictions as set in the image processing apparatus have to be set in every portable information device, and the setting operation is cumbersome. The operation of setting the same restrictions imposed on the image processing apparatus in a portable information device is particularly difficult because an application program for remotely controlling an MFP can be readily downloaded onto a portable information device.

### SUMMARY OF THE INVENTION

In order to achieve the aforementioned object, according to an aspect of the present invention, a portable information device includes a controller that executes: a pre-setting acquisition step of acquiring device identification information for identifying an image processing apparatus to execute a job and a unique setting value that is a setting value preset in the image processing apparatus; a setting step of setting a setting value; a job generation step of generating a job based on the set setting value; and a job transmission step of transmitting the generated job to the image processing apparatus specified by the device identification information acquired in the pre-setting acquisition step. The setting step includes an initial setting step of setting the acquired unique setting value in response to the unique setting value being acquired in the pre-setting acquisition step.

According to another aspect of the present invention, an image processing system includes an image processing apparatus that executes a job and a remote control device that remotely controls the image processing apparatus. The image processing apparatus includes: a first device-side communication portion capable of communication within a range of a predetermined distance; a storage portion to store device identification information for identifying the image processing apparatus and a unique setting value that is a setting value preset in the image processing apparatus; a device-side transmission portion configured to control the first device-side communication portion to transmit the stored device identification information and unique setting value to the remote control device, in response to the first device-side communication portion becoming able to communicate with the remote control device; a second device-side communication portion different from the first device-side communication portion; and a job executing portion configured to, if the second device-side communication portion receives a job from the remote control device, execute the received job. The remote control device includes: a setting portion configured to set a setting value; a job generating portion configured to generate a job based on the set setting value; a first communication portion capable of communicating with the first device-side communication portion; a second communication portion different from the first communication portion; a reception control portion configured to control the first communication portion to receive the device identification information and the unique setting value from the image processing apparatus, in response to the first communication portion becoming able to communicate with the first device-side communication portion; a communication control portion configured to control the second communication portion to establish a communication link with the image processing apparatus, using the device identification information acquired by the reception control portion; and a job transmitting portion configured to transmit the generated job using the communication link established by the communication control portion. The setting portion includes an initial setting portion configured to set the acquired unique setting value, in response to the unique setting value being received by the reception control portion.

According to a further aspect of the present invention, a remote operation method allows a portable information device to execute: a pre-setting acquisition step of acquiring device identification information for identifying an image processing apparatus to execute a job and a unique setting value that is a setting value preset in the image processing apparatus; a setting step of setting a setting value; a job generation step of generating a job based on the set setting value; and a job transmission step of transmitting the generated job to the image processing apparatus specified by the device identification information acquired in the pre-setting acquisition step. The setting step includes an initial setting step of setting the acquired unique setting value, in response to the unique setting value being acquired in the pre-setting acquisition step.

According to yet another aspect of the present invention, a non-transitory computer-readable recording medium is encoded with a remote operation program that allows a computer controlling a portable information device to execute: a pre-setting acquisition step of acquiring device identification information for identifying an image processing apparatus to execute a job and a unique setting value that is a setting value preset in the image processing apparatus; a setting step of setting a setting value; a job generation step of generating a job based on the set setting value; and a job transmission step of transmitting the generated job to the image processing apparatus specified by the device identification information acquired in the pre-setting acquisition step. The setting step includes an initial setting step of setting the acquired unique setting value, in response to the unique setting value being acquired in the pre-setting acquisition step.

According to this aspect, a remote operation program that facilitates the setting for allowing an image processing apparatus to execute a process is provided.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram showing an overview of an image processing system in an embodiment of the present invention.

FIG. 2 is an external view of an MFP.

FIG. 3 is a block diagram showing the overall hardware configuration of the MFP.

FIG. 4 is a plan view of an example of an operation panel.

FIG. 5 is a block diagram showing the overall hardware configuration of a portable information device in a first embodiment.

FIG. 6 is a block diagram showing exemplary functions of the CPU of the portable information device in the first embodiment.

FIG. 7 is a block diagram showing exemplary functions of the CPU of the MFP in the first embodiment.

FIG. 8 is a flowchart showing an example of a remote operation process in the first embodiment.

FIG. 9 is a flowchart showing an example of the procedure of a remote control process in the first embodiment.

FIG. 10 is a block diagram showing exemplary functions of the CPU of the MFP in a modification to the first embodiment.

FIG. 11 is a diagram showing an example of the hardware configuration of the MFP in a second embodiment.

FIG. 12 is a diagram showing exemplary functions of the CPU of the portable information device in the second embodiment.

FIG. 13 is a diagram showing exemplary functions of the CPU of the MFP in the second embodiment.

FIG. 14 is a flowchart showing an example of a remote operation process in the second embodiment.

FIG. 15 is a flowchart showing an example of the procedure of a remote control process in the second embodiment.

FIG. 16 is a diagram showing an example of the hardware configuration of the MFP in a third embodiment.

FIG. 17 is a diagram showing an example of the hardware configuration of the portable information device in the third embodiment.

FIG. 18 is a diagram showing exemplary functions of the CPU of the portable information device in the third embodiment.

FIG. 19 is a diagram showing exemplary functions of the CPU of the MFP in the third embodiment.

FIG. 20 is a flowchart showing an example of a remote operation process in the third embodiment.

FIG. 21 is a flowchart showing an example of the procedure of a remote control process in the third embodiment.

FIG. 22 is a diagram showing an example of the hardware configuration of the portable information device in a fourth embodiment.

FIG. 23 is a diagram showing exemplary functions of the CPU of the MFP in the fourth embodiment.

FIG. 24 is a plan view showing an example of the operation panel on which a two-dimensional bar code appears.

FIG. 25 is a diagram showing exemplary functions of the CPU of the portable information device in the fourth embodiment.

FIG. 26 is a flowchart showing an example of a remote operation process in the fourth embodiment.

### DESCRIPTION OF THE PREFERRED EMBODIMENTS

Embodiments of the present invention will be described below in conjunction with the figures. In the following description, the same parts are denoted with the same reference signs. Their names and functions are also the same. A detailed description thereof is not repeated.

FIG. 1 is a diagram showing an overview of an image processing system in an embodiment of the present invention. Referring to FIG. 1, image processing system 1 includes a Multi Function Peripheral (hereinafter referred to as “MFP”) 100 and portable information devices 200, 200A. MFP 100 is connected to a network 3.

Portable information devices 200, 200A are computers such as smartphones, tablet terminals, and PDAs (Personal Digital Assistants) carried by users. Here, portable information devices 200, 200A are smartphones, by way of example. Portable information devices 200, 200A each have a call function and communicate with a mobile phone base station by radio to connect to a mobile phone network to make a call.

Network 3 is a local area network (LAN), either wired or wireless. Network 3 is not limited to a LAN but may be, for example, a network using the Public Switched Telephone Network.

Radio station 5 is a relay for network 3 and communicates with portable information devices 200, 200A having the wireless LAN communication function to connect portable information devices 200, 200A to network 3. Portable information devices 200, 200A thus transmit/receive data to/from MFP 100 through radio station 5 and network 3.

Although MFP 100 is connected to network 3 in this example, it may be connected to the Internet. The connection may be either wired or wireless. Although FIG. 1 shows image processing system 1 including a single MFP 100, the number of MFPs is not limited and may be one or more. Although image processing system 1 including two portable information devices 200, 200A is shown, the number of portable information devices is not limited and may be one or more. The respective functions of portable information devices 200, 200A are the same. Portable information device 200 will be described as an example unless otherwise specified.

In image processing system 1 in the present embodiment, portable information devices 200, 200A each communicate with MFP 100 and remotely operate MFP 100 to allow MFP 100 to execute a process. In the example described here, portable information device 200 remotely operates MFP 100 and allows MFP 100 to execute a print process of forming an image on paper among a plurality of processes executable by MFP 100. In this case, setting values of a plurality of setting items have to be set in portable information device 200 in order to allow MFP 100 to execute a print process. The setting items include, for example, the number of copies indicating the number of sheets on which an image is formed, color selection indicating the number of colors of an image, the print type indicating a surface of paper on which an image is formed, and the page layout indicating the number of pages of an image formed onto a sheet of paper.

MFP 100 has a default setting value defined by the administrator of MFP 100 for each of a plurality of setting items. The default setting value set in MFP 100 by the administrator for each of a plurality of setting items is referred to as a unique setting value.

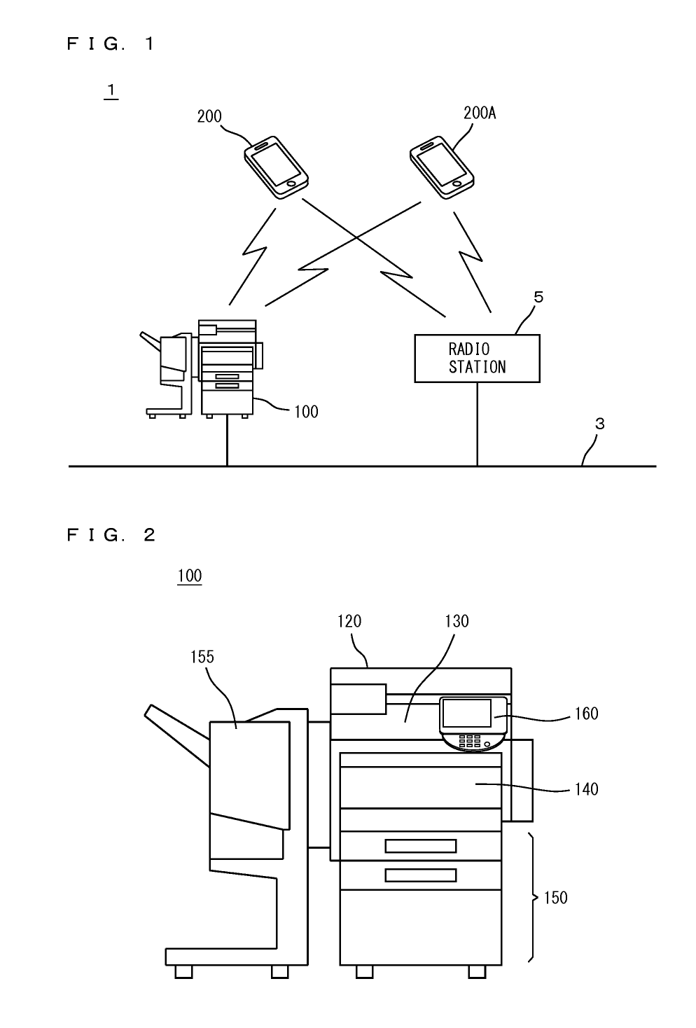

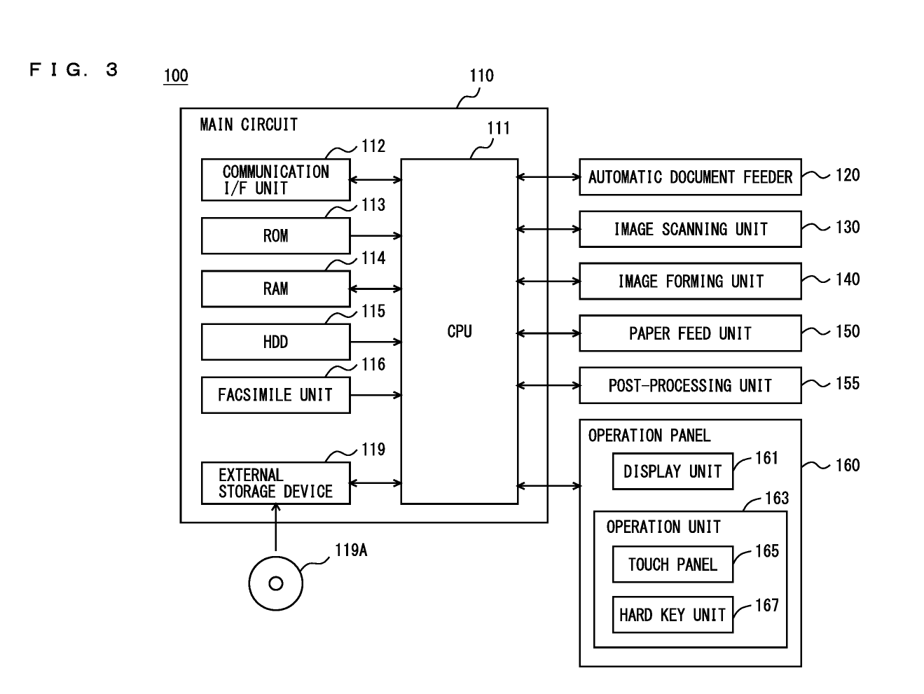

FIG. 2 is an external view of the MFP. FIG. 3 is a block diagram showing the overall hardware configuration of the MFP in the first embodiment. Referring to FIG. 2 and FIG. 3, MFP 100 includes a main circuit 110, a document scanning unit 130 for scanning a document, an automatic document feeder 120 for conveying a document to document scanning unit 130, an image forming unit 140 for forming an image on paper or other medium based on image data output by document scanning unit 130 scanning a document, a paper feed unit 150 for supplying paper to image forming unit 140, a post-processing unit 155 for processing paper having an image formed thereon, and an operation panel 160 serving as a user interface.

Post-processing unit 155 executes a sorting process of sorting one or more sheets of paper having an image formed by image forming unit 140 and discharging the sorted paper, a punching process of punching a hole, and a stapling process of pushing staples.

Main circuit 110 includes a CPU 111, a communication interface (I/F) unit 112, a ROM 113, a RAM 114, a hard disk drive (HDD) 115 serving as a mass storage device, a facsimile unit 116, and an external storage device 119 to which a CD-ROM (Compact Disc ROM) 119A is attached. CPU 111 is connected with automatic document feeder 120, document scanning unit 130, image forming unit 140, paper feed unit 150, post-processing unit 155, and operation panel 160 for controlling the entire MFP 100.

ROM 113 stores a program executed by CPU 111 or data necessary for executing the program. RAM 114 is used as a working area when CPU 111 executes a program.

Communication I/F unit 112 is an interface for connecting MFP 100 to network 3. CPU 111 communicates with portable information devices 200, 200A connected with radio station 5 through communication I/F unit 112 to transmit/receive data.

Facsimile unit 116 is connected to the Public Switched Telephone Network (PSTN) and transmits facsimile data to the PSTN or receives facsimile data from the PSTN. Facsimile unit 116 stores the received facsimile data into HDD 115 or outputs the received facsimile data to image forming unit 140. Image forming unit 140 prints facsimile data received by facsimile unit 116 on paper. Facsimile unit 116 converts the data stored in HDD 115 into facsimile data and transmits the facsimile data to a facsimile machine connected to the PSTN.

CD-ROM 119A is attached to external storage device 119. CPU 111 can access CD-ROM 119A through external storage device 119. CPU 111 loads a program recorded on CD-ROM 119A attached to external storage device 119 into RAM 114 for execution. The medium that stores a program executed by CPU 111 is not limited to CD-ROM 119A but may be an optical disc (MO (Magnetic Optical Disc)/MD (Mini Disc)/DVD (Digital Versatile Disc)), an IC card, an optical card, or a semiconductor memory such as a mask ROM, an EPROM (Erasable Programmable ROM), and an EEPROM (Electrically EPROM).

The program executed by CPU 111 is not limited to a program recorded on CD-ROM 119A. A program stored in HDD 115 may be loaded onto RAM 114 for execution. In this case, another computer connected to network 3 may overwrite the program stored in HDD 115 of MFP 100 or additionally write a new program. MFP 100 may download a program from another computer connected to network 3 and store the program into HDD 115. The program referred to here includes not only a program directly executable by CPU 111 but also a source program, a compressed program, and an encrypted program.

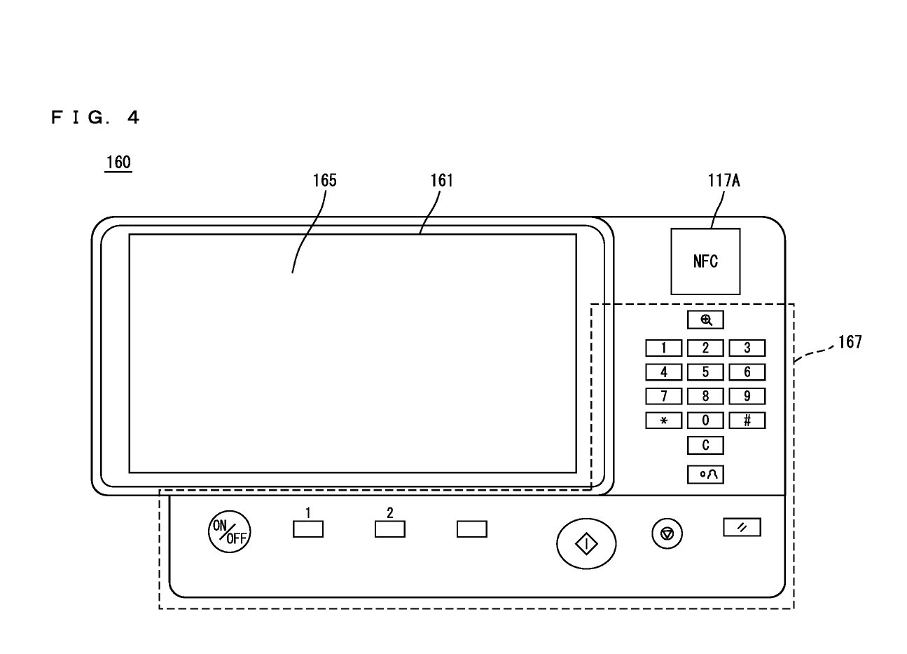

FIG. 4 is a plan view of an example of the operation panel. Referring to FIG. 4, operation panel 160 includes a display unit 161 and an operation unit 163. The dotted line in the figure is provided to indicate a hard key unit 167 and actually not present. Display unit 161 is a display such as a liquid crystal display device (LCD) and an organic ELD (Electro-Luminescence Display) and displays, for example, instruction menus to users and information of acquired image data.

Operation unit 163 includes a touch panel 165 and a hard key unit 167. Touch panel 165 is superimposed on the top surface or the bottom surface of display unit 161. Hard key unit 167 includes a plurality of hard keys. The hard keys are, for example, contact switches. Touch panel 165 detects the position designated by the user in the display surface of display unit 161.

An NFC tag 117A is attached to the top surface of operation unit 163. NFC tag 117A is a passive tag including a near-field wireless communication unit and a memory. NFC tag 117A is driven by induced current produced by a changing magnetic field as electromotive force. The memory of NFC tag 117A includes device identification information for identifying MFP 100 and unique setting information unique to MFP 100. The unique setting information will be described later.

Users usually operate MFP 100 in the standing position, and the display surface of display unit 161, the operation surface of touch panel 165, NFC tag 117A, and hard key unit 167 are arranged face up. This allows users to easily view the display surface of display unit 161 and easily point on operation unit 163 with the finger.

Although NFC tag 117A is affixed to the top surface of operation unit 163 in the present embodiment, NFC tag 117A may be suspended on the side surface of MFP 100 or affixed to a wall surface in the vicinity of MFP 100 as long as it is arranged in association with MFP 100.

NFC tag 117A stores the device identification information for identifying MFP 100 and the unique setting information of MFP 100 in the memory. The unique setting information is information indicating a set of a unique setting value set by the administrator in MFP 100 and the setting item in which the unique setting value is set. The unique setting information defines a unique setting value defined by the administrator in advance for each of a plurality of setting items for MFP 100.

The unique setting information includes items of setting item, unique setting value, and restriction flag. A plurality of setting items for a print process among a plurality of processes executable by MFP 100 are items of number of copies, color selection, print type, and page layout. The item of number of copies indicates the number of sheets of paper on which MFP 100 forms an image. The item of color selection indicates the setting of number of colors in which MFP 100 forms an image, and is set to either a setting value “color” indicating image formation in multiple colors or a setting value “grayscale” indicating image formation in black and white. The item of print type indicates the setting of a surface of paper on which an image is formed, and includes a setting value “single side” for forming an image on one side of paper and “double side” for forming an image on both sides of paper. The item of page layout indicates the setting of number of pages included in an image formed on one sheet of paper and is set to either a setting value “OFF” indicating the setting in which one page of an image is formed on one sheet of paper or a setting value “4in1” indicating the setting in which four pages of an image are formed on one sheet of paper.

The item of restriction flag indicates whether a setting value other than the unique setting value can be set for a setting item. The item of restriction flag is set to “change permitted” if a setting value other than the unique setting value can be set for the setting item, and set to “change not permitted” if a setting value other than the unique setting value cannot be set for the setting item.

The device identification information and the unique setting information stored in the memory of NFC tag 117A are stored by the administrator who manages MFP 100 into the memory of NFC tag 117A. For example, when portable information device 200A is allocated to the administrator, the administrator uses portable information device 200A to write the device identification information and the unique setting information of MFP 100 into the memory of NFC tag 117A. Any device other than portable information device 200 that can write data into NFC tag 117A, for example, a personal computer may be used to write the device identification information and the unique setting information of MFP 100 into the memory of NFC tag 117A.

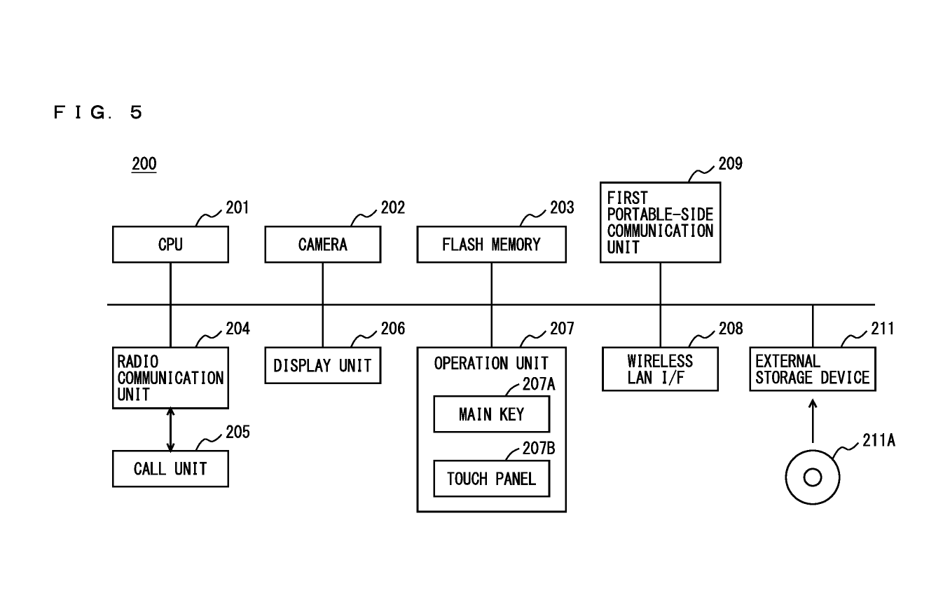

FIG. 5 is a block diagram showing the overall hardware configuration of the portable information device in the first embodiment. Referring to FIG. 5, portable information device 200 in the present embodiment includes a CPU 201 for controlling the entire portable information device 200, a camera 202, a flash memory 203 for storing data in a nonvolatile manner, a radio communication unit 204 connected to a call unit 205, a display unit 206 for displaying an image, an operation unit 207 for accepting the user's operation, a wireless LAN I/F 208, a first portable-side communication unit 209, and an external storage device 211.

Display unit 206 is a display device such as a liquid crystal display device (LCD) and an organic ELD and displays, for example, instruction menus to the user and information about the acquired image data. Operation unit 207 includes a main key 207A and a touch panel 207B. When the user points on the display surface of display unit 206, operation unit 207 outputs the position of the display surface detected by touch panel 207B to CPU 201. CPU 201 detects the position designated by the user in the screen appearing on display unit 206, based on the position detected by touch panel 207B. CPU 201 accepts input of various instructions and data such as characters and numerals through the user's operation, based on the screen appearing on display unit 206 and the position detected by touch panel 207B. For example, when a screen including a ten-key image appears on display unit 206, the numeral corresponding to the key displayed at the position detected by touch panel 207B is accepted.

Camera 202 includes a lens and a photoelectric transducer. Light collected by the lens is imaged on the photoelectric transducer, and the photoelectric transducer transduces the received light and outputs image data to CPU 201. The photoelectric transducer is, for example, a CMOS (Complementary Metal Oxide Semiconductor) sensor or a CCD (Charge Coupled Device) sensor.

Radio communication unit 204 communicates by radio with a mobile phone base station connected to a telephone communication network. Radio communication unit 204 connects portable information device 200 to a telephone communication network to enable a call using call unit 205. Radio communication unit 204 decodes a voice signal obtained by demodulating a radio signal received from a mobile phone base station and outputs the decoded signal to call unit 205. Radio communication unit 204 encodes voice input from call unit 205 and transmits the encoded voice to a mobile phone base station. Call unit 205 includes a microphone and a speaker, and outputs voice input from radio communication unit 204 from the speaker and outputs voice input from the microphone to radio communication unit 204. Radio communication unit 204 is controlled by CPU 201 and connects portable information device 200 to an email server to transmit/receive emails.

Wireless LAN I/F 208 is an interface for wireless communication of portable information device 200 based on the Wi-Fi standards. The IP (Internet Protocol) address of MFP 100 is registered in portable information device 200 so that portable information device 200 can communicate with MFP 100 to transmit/receive data.

Flash memory 203 stores a program executed by CPU 201 or data necessary for executing the program. CPU 201 loads a program stored in flash memory 203 into the RAM of CPU 201 for execution. Flash memory 203 stores device identification information for identifying portable information device 200 and user identification information for identifying the user allocated as a user supposed to use portable information device 200.

First portable-side communication unit 209 communicates based on the NFC standards when the distance to MFP 100 is equal to or shorter than a first distance. The first distance is, for example, ten and a few centimeters. First portable-side communication unit 209 may be an interface for wireless communication based on the Bluetooth (registered trademark) standards or the IrDA (Infrared Data Association) standards.

External storage device 211 is removably attached to portable information device 200, and a CD-ROM 210A storing a device-side cooperation program can be attached thereto. CPU 201 can access CD-ROM 210A through external storage device 211. CPU 201 can load a program recorded on CD-ROM 210A attached to external storage device 211 into the RAM of CPU 201 for execution.

The medium for storing a program executed by CPU 201 is not limited to CD-ROM 211A but may be an optical disc (MO/MD/DVD), an IC card, an optical card, or a semiconductor memory such as a mask ROM, an EPROM, and an EEPROM.

Although the program stored in flash memory 203 or CD-ROM 210A has been described as a program executed by CPU 201, another computer connected to the Internet may overwrite the program stored in flash memory 203 or additionally write a new program. Alternatively, portable information device 200 may download a program from another computer connected to the Internet. The program referred to here includes not only a program directly executable by CPU 201 but also a source program, a compressed program, and an encrypted program.

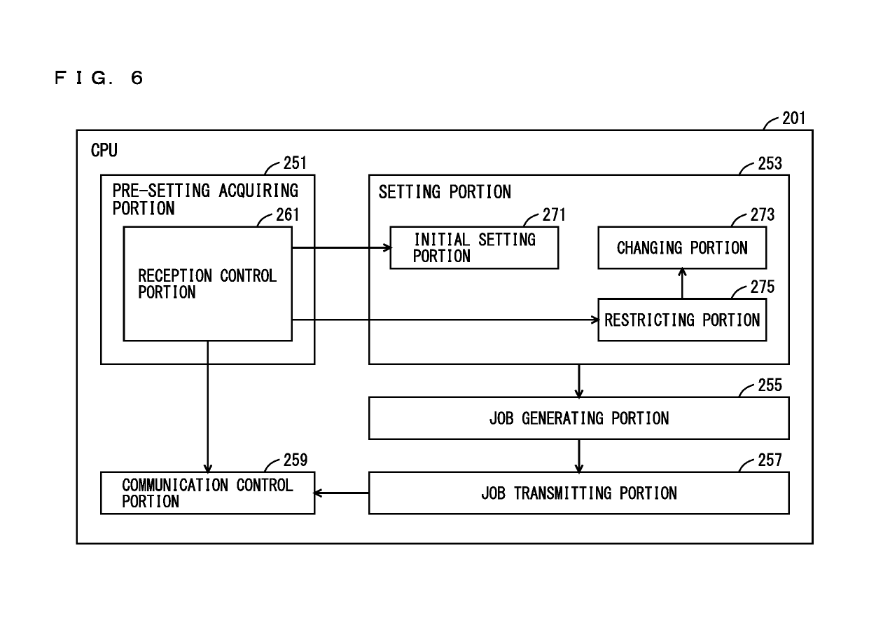

FIG. 6 is a block diagram showing exemplary functions of the CPU of the portable information device in the first embodiment. The functions shown in FIG. 6 are formed in CPU 201 by CPU 201 of portable information device 200 executing a remote operation program. Referring to FIG. 6, CPU 201 of portable information device 200 includes a pre-setting acquiring portion 251, a setting portion 253 for setting a setting value, a job generating portion 255 for generating a job based on a setting value, a job transmitting portion 257 for transmitting a job to MFP 100, and a communication control portion 259.

Pre-setting acquiring portion 251 acquires the device identification information and the unique setting information of MFP 100. Pre-setting acquiring portion 251 includes a reception control portion 261. Reception control portion 261 controls first portable-side communication unit 209 such that the device identification information and the unique setting information are received from NFC tag 117A when first portable-side communication unit 209 becomes able to communicate with NFC tag 117A. In other words, reception control portion 261 receives the device identification information and the unique setting information from NFC tag 117A when portable information device 200 comes closer within the first distance from NFC tag 117A. Reception control portion 261 outputs the device identification information of MFP 100 received from NFC tag 117A to communication control portion 259 and outputs the unique setting information of MFP 100 received from NFC tag 117A to setting portion 253.

Setting portion 253 sets setting values in a plurality of setting items and outputs the respective setting values of the setting items to job generating portion 255. A plurality of setting items for a print process among a plurality of processes executable by MFP 100 are the items of number of copies, color selection, print type, and page layout. Setting portion 253 initially sets a default setting value set in portable information device 200 for each of the items of number of copies, color selection, print type, and page layout.

Setting portion 253 includes an initial setting portion 271, a changing portion 273, and a restricting portion 275. In response to input of unique setting information from reception control portion 261, initial setting portion 271 sets a unique setting value included in the unique setting information for the corresponding setting item. Initial setting portion 271 sets the unique setting value included in the unique setting information in the corresponding setting item before changing portion 273 described later displays a setting screen on display unit 206. Specifically, a default setting value set in portable information device 200 is updated with the unique setting value included in the unique setting information, for each of the items of number of copies, color selection, print type, and page layout.

Restricting portion 275 receives the unique setting information from reception control portion 261. Restricting portion 275 restricts a change to the setting value by changing portion 273, for the setting item with the item of restriction flag set to “change not permitted” among a plurality of setting items included in the unique setting information. Restricting portion 275 outputs to changing portion 273 the item identification information of the setting item with the item of restriction flag set to “change not permitted” among a plurality of setting items included in the unique setting information.

Changing portion 273 displays a setting screen for setting a setting value on display unit 206. If the user inputs an operation of changing a setting value to operation unit 207 in accordance with the setting screen, the setting value changed by the user is set. For example, if a default setting value is set in a setting item, changing portion 273 updates the default setting value with the setting value changed by the user. If a unique setting value is set in a setting item, changing portion 273 updates the unique setting value with the setting value changed by the user on condition that the item identification information of that setting item is not input from restricting portion 275. Specifically, if a unique setting value is set in a setting item and the item identification information of the setting item is not input from restricting portion 275, changing portion 273 updates the unique setting value with the setting value changed by the user. If a unique setting value is set in a setting item and the item identification of the setting item is input from restricting portion 275, changing portion 273 does not update the unique setting value with the setting value changed by the user.

Setting portion 253 sets data to be processed in a print process. A data designation screen appears on display unit 206, and the data designated by the user in accordance with the data designation screen is set as data to be processed. Setting portion 253 outputs the data set as a target to be processed to job generating portion 255.

Job generating portion 255 receives a setting value for each of a plurality of setting items from setting portion 253 and generates a job based on the setting value. When a setting value for each of a plurality of setting items for a print process is input, job generating portion 255 receives data to be processed from setting portion 253 and generates a job based on the data to be processed and the setting value set for each of a plurality of setting items. Job generating portion 255 outputs the generated job to job transmitting portion 257.

Communication control portion 259 controls wireless LAN I/F 208. Communication control portion 259 receives the device identification information of MFP 100 from pre-setting acquiring portion 251 and controls wireless LAN I/F 208 to establish a communication link with MFP 100 using the device identification information.

Job transmitting portion 257 transmits the job input from job generating portion 255 to MFP 100 using the communication link established by communication control portion 259.

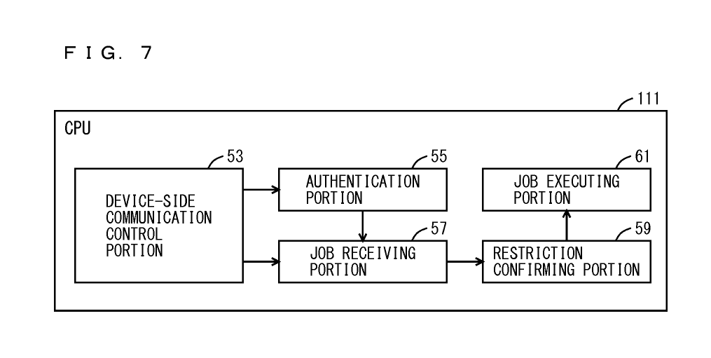

FIG. 7 is a functional block diagram showing exemplary functions of the CPU of the MFP in the first embodiment. The functions shown in FIG. 7 are formed in CPU 111 by CPU 111 of MFP 100 executing a remote control program. Referring to FIG. 7, CPU 111 of MFP 100 includes a device-side communication control portion 53, an authentication portion 55, a job receiving portion 57, a restriction confirming portion 59, and a job executing portion 61.

Device-side communication control portion 53 controls communication I/F unit 112. When communication I/F unit 112 accepts a connection request from portable information device 200, device-side communication control portion 53 establishes a communication link with portable information device 200. When establishing a communication link with portable information device 200, device-side communication control portion 53 outputs the device identification information for identifying portable information device 200 to authentication portion 55.

In response to input of the device identification information of portable information device 200, authentication portion 55 authenticates the user who operates portable information device 200. A set of the user identification information of the user authorized to operate MFP 100 and the device identification information of the device allocated to that user is stored in HDD 115. If the device identification information input from device-side communication control portion 53 is stored in HDD 115, authentication portion 55 authenticates the user specified by the user identification information paired with that device identification information and outputs an authentication success signal to job receiving portion 57. Subsequently, the job received via the communication link established by device-side communication control portion 53 with portable information device 200 is handled as a job based on the instruction by the authenticated user. If the device identification information input from device-side communication control portion 53 is not stored in HDD 115, authentication portion 55 outputs a cutoff instruction to device-side communication control portion 53. In response to input of a cutoff instruction from authentication portion 55, device-side communication control portion 53 cuts off the communication link established with portable information device 200.

The method of authenticating the user who operates portable information device 200 is not limited thereto. For example, when a set of the user identification information of a user authorized to operate MFP 100 and a password is stored in HDD 115, authentication portion 55 may transmit a signal for requesting user identification information and a password through the communication link established by device-side communication control portion 53 and authenticate the user who operates portable information device 200 using the user identification information and the password received from portable information device 200. In this case, at portable information device 200, communication control portion 259 returns user identification information and a password in response to reception of the signal for requesting user identification information and a password from MFP 100 and, if authenticated by MFP 100, maintains the communication link. The user identification information and the password may be stored in flash memory 203 beforehand, or the user may input the user identification information and the password to operation unit 207.

Job receiving portion 57 acquires a job received by communication I/F unit 112 through the communication link established by device-side communication control portion 53 with portable information device 200. Job receiving portion 57 outputs the received job to restriction confirming portion 59. Restriction confirming portion 59 determines whether the setting value set in the received job falls within a limited range. Restriction confirming portion 59 outputs the job to job executing portion 61 on condition that the setting value set in the received job is within the limited range. If outside the limited range, the job is discarded. Restriction information that defines a range in which a setting value is limited is stored in HDD 115, and the restriction information is used to determine whether the setting value set in the received job falls within the limited range. A unique setting value that is a default setting value is defined by the administrator for each of a plurality of setting items in MFP 100. The limited range may be defined in addition to the unique setting value. In response to input of a job from restriction confirming portion 59, job executing portion 61 executes the job.

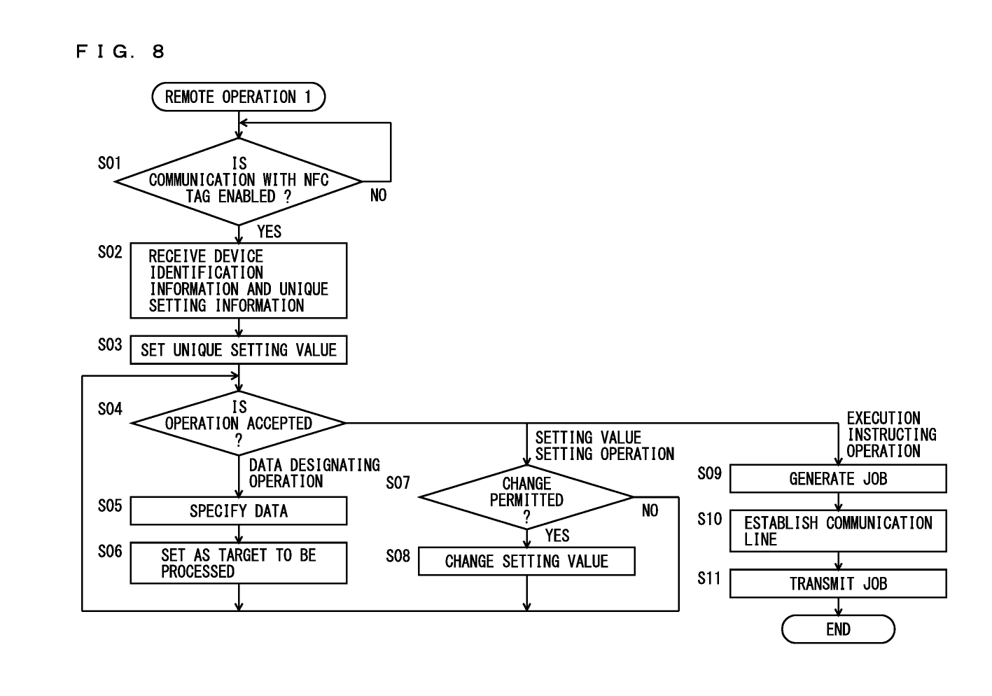

FIG. 8 is a flowchart showing an example of a remote operation process in the first embodiment. The remote operation process is a process executed by CPU 201 by CPU 201 of each of portable information devices 200, 200A executing a remote operation program. Here, CPU 201 of portable information device 200 executes the remote operation program, by way of example. Referring to FIG. 8, CPU 201 determines whether communication with NFC tag 117A is enabled (step S01). The process waits until first portable-side communication unit 209 becomes able to communicate with NFC tag 117A affixed to MFP 100 (NO in step S01). If first portable-side communication unit 209 becomes able to communicate with NFC tag 117A (YES in step S01), the process proceeds to step S02. The range over which first portable-side communication unit 209 can communicate is ten and a few centimeters. When the user brings portable information device 200 closer to NFC tag 117A within ten and a few centimeters from NFC tag 117A, first portable-side communication unit 209 becomes able to communicate with NFC tag 117A.

In step S02, first portable-side communication unit 209 is controlled such that the device identification information and the unique setting information are received from NFC tag 117A. The unique setting value included in the unique setting information is set for each of a plurality of setting items included in the unique setting information (step S03). The default setting value set in portable information device 200 is updated with the unique setting value included in the unique setting information.

In the next step S04, it is determined whether an operation is accepted. If operation unit 207 accepts an operation input by the user, it is determined that an operation is accepted. In step S04, the process branches depending on the kind of the accepted operation. Here, the operation accepted by operation unit 207 includes a data designating operation of designating data to be processed, a setting value setting operation of changing a setting value, and an execution instructing operation of giving an instruction to execute a job. If the operation accepted in step S04 is a data designating operation, the process proceeds to step S05. If a setting value setting operation, the process proceeds to step S07. If an execution instructing operation, the process proceeds to step S09.

In step S05, data is specified based on the data designating operation. For example, a data designation screen appears on display unit 206, and data designated by the user is specified. The data may be data stored in flash memory 203 or data stored, for example, in a server connected to network 3. In step S06, the data specified in step S05 is set as a target to be processed. The process then returns to step S04.

In step S07, it is determined whether the setting value changed through the setting value setting operation can be changed. The determination is made based on the value set in the item of restriction flag corresponding to the setting item of the setting value changed through the setting value setting operation, in the unique setting information received in step S02. If the item of restriction flag is set to “change permitted”, the process proceeds to step S08. If the item of restriction flag is set to “change not permitted”, the process returns to step S04. When the item of restriction flag is set to “change not permitted”, the user who operates portable information device 200 may be notified that a change is not permitted. For example, a message may appear on display unit 206 or buzzer sound may be produced. In step S08, the setting value set so far is changed to the setting value changed through the setting value setting operation. The process then returns to step S04.

The process proceeds to step S09 when an execution instructing operation is accepted. In step S09, a job is generated in accordance with the data sets as a target to be processed in step S06 and the setting value set so far. In the next step S10, wireless LAN I/F 208 is controlled such that a communication link is established with MFP 100 specified by the device identification information received in step S02. The job generated in step S09 is then transmitted using the established communication link (step S11). The process then ends.

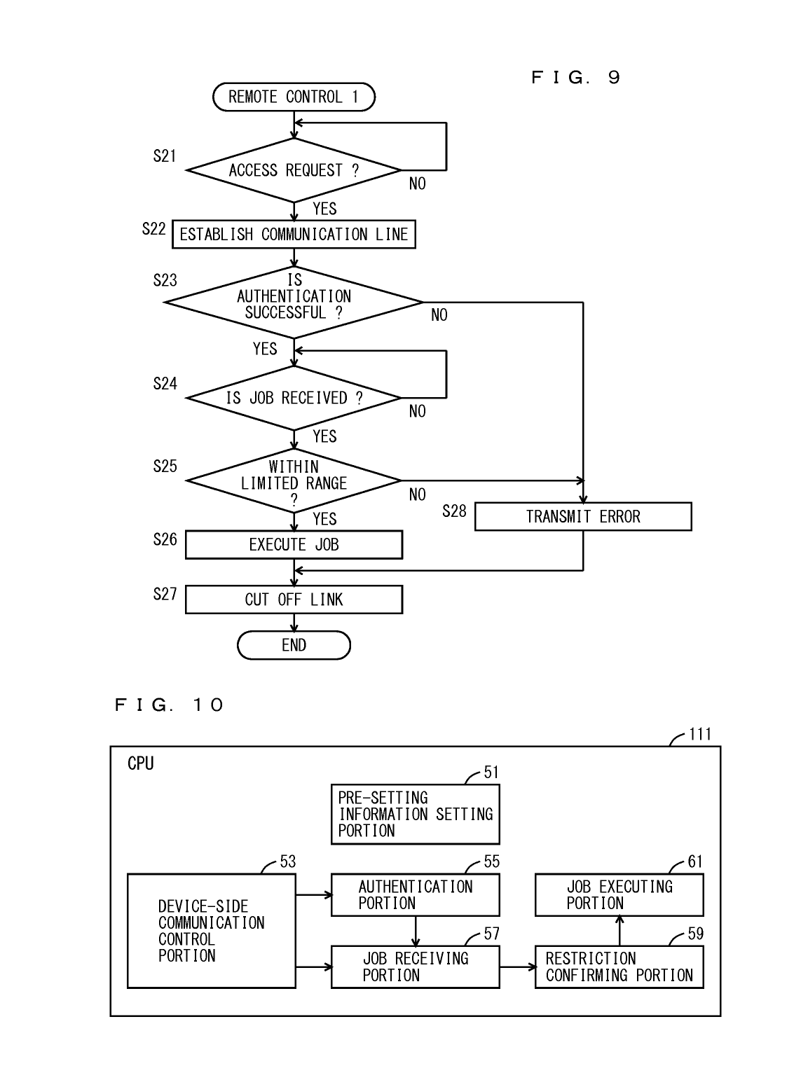

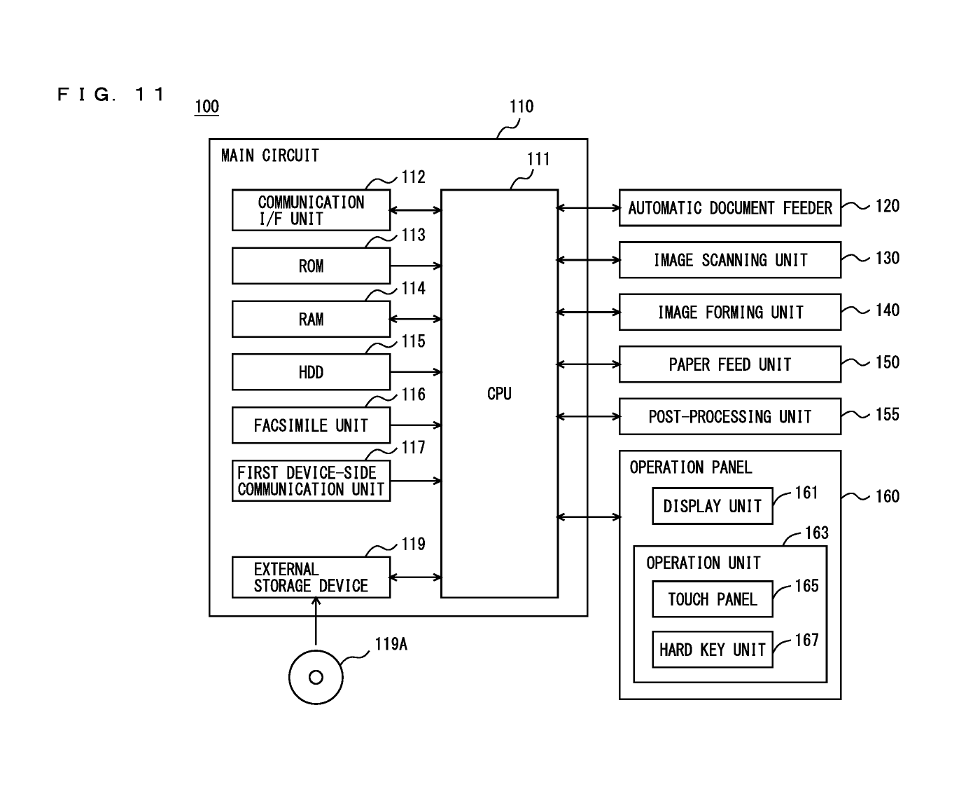

FIG. 9 is a flowchart showing an example of the procedure of a remote control process in the first embodiment. The remote control process is executed by CPU 111 by CPU 111 of MFP 100 executing a remote control program. Referring to FIG. 9, CPU 111 determines whether communication I/F unit 112 receives an access request from any one of portable information devices 200, 200A. The process waits until communication I/F unit 112 receives an access request from any one of portable information devices 200, 200A (NO in step S21). If an access request is received (YES in step S21), the process proceeds to step S22. Here, an access request is received from portable information device 200, by way of example.

In the next step S22, a communication link is established with portable information device 200. The user who operates portable information device 200 is then authenticated. It is determined whether a set of the device identification information of portable information device 200 that has transmitted the access request and the user identification information is stored in HDD 115 beforehand. If a set of the device identification information of portable information device 200 that has transmitted the access request and the user identification information is stored in HDD 115 beforehand, the user who operates portable information device 200 is authenticated as the user specified by that user identification information. If not, the user is not authenticated. If the user who operates portable information device 200 is authenticated, the process proceeds to step S24. If not, the process proceeds to step S28.

In step S24, it is determined whether a job is received through the communication link established in step S22. The process waits until a job is received (NO in step S24). If a job is received (YES in step S24), the process proceeds to step S25. In step S25, it is determined whether the setting value included in the job falls within the limited range. If within the limited range, the process proceeds to step S26. If not, the process proceeds to step S28. Restriction information that defines a range in which a setting value is limited is stored in HDD 115, and the restriction information is used to determine whether the setting value set in the received job is within the limited range.

In step S26, the job received in step S24 is executed, and the process proceeds to step S27. In step S27, the communication link established in step S22 is cut off. The process then ends. In step S28, an error is transmitted to portable information device 200 through the communication link established in step S22. The process then proceeds to step S27. This is to notify portable information device 200 that the job cannot be executed.

<Modification>

In the foregoing first embodiment, NFC tag 117A affixed to MFP 100 is a passive tag. MFP 100 in a modification includes an active NFC tag 117B. The differences from the image processing system in the first embodiment are mainly described below. In NFC tag 117B in the modification, the content of the memory of NFC tag 117B can be rewritten by CPU 111.

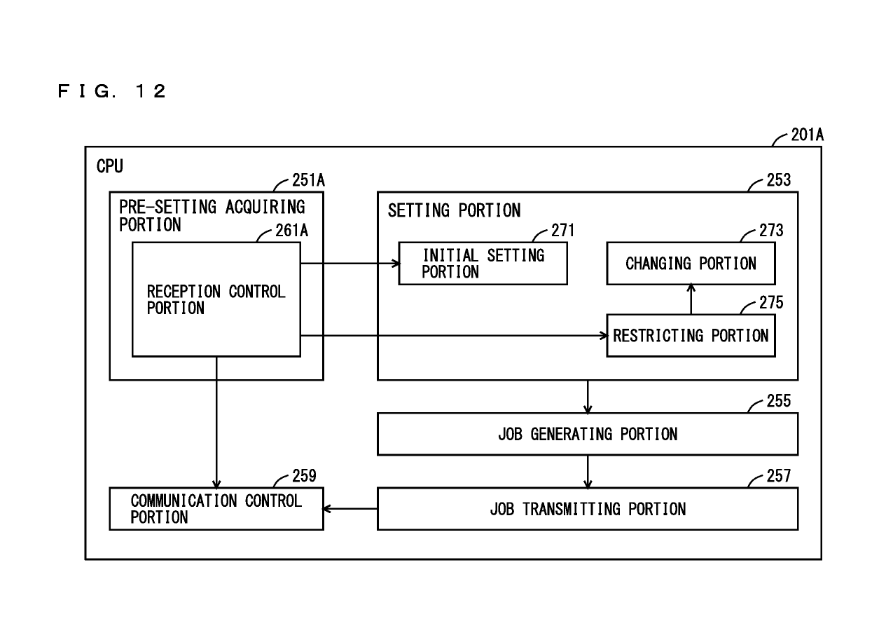

FIG. 10 is a block diagram showing exemplary functions of the CPU of the MFP in the modification to the first embodiment. The functions shown in FIG. 10 differ from the functions shown in FIG. 7 in that a pre-setting information setting portion 51 is added. The other functions are the same as the functions shown in FIG. 7 and a description thereof is not repeated here. Referring to FIG. 10, pre-setting information setting portion 51 stores the device identification information and the unique setting information of MFP 100 into the memory of NFC tag 117B. The device identification information and the unique setting information of MFP 100 are stored in HDD 115 beforehand as a default unique setting value and restriction information set in MFP 100.

Pre-setting information setting portion 51 may store the device identification information and the unique setting information of MFP 100 into the memory of NFC tag 117B when the user who manages MFP 100 operates operation unit 163 to input a write instruction. Pre-setting information setting portion 51 may store the device identification information and the unique setting information of MFP 100 into the memory of NFC tag 117B every time the unique setting value or the restriction information is changed.

As described above, portable information device 200 in the first embodiment acquires the device identification information and the unique setting information of MFP 100 from NFC tag 117A when coming closer within the first distance from NFC tag 117A affixed to MFP 100, sets the unique setting value included in the unique setting information, generates a job based on the set setting value, and transmits the job to MFP 100 specified by the device identification information. With the operation of bringing portable information device 200 closer within the first distance from NFC tag 117A affixed to MFP 100, the unique setting value that is a setting value set by the administrator in MFP 100 can be set in portable information device 200, and MFP 100 that is a destination to which the job is transmitted can be set in portable information device 200. MFP 100 can execute a job executable by MFP 100 because a job generated based on the unique setting value of MFP 100 is transmitted to MFP 100.

Since a unique setting value is set before a setting screen for accepting input of a setting value appears, the user can be notified of the unique setting value before the user sets a setting value. The unique setting value is prevented from being changed, for the setting item with the item of restriction flag set to “change not permitted” in the unique setting information, so that a setting value that can be set in portable information device 200 can be limited to a range that can be set in MFP 100.

A job including large volume data can be transmitted to MFP 100 because wireless LAN I/F 208 is controlled such that a communication link is established with MFP 100 and a job is transmitted using the established link.

### Second Embodiment

The image processing system in a second embodiment differs from the image processing system in the first embodiment in that MFP 100 has a function of communicating with portable information device 200 in accordance with the NFC standards. The differences from the image processing system in the first embodiment are mainly described below.

The overview of the image processing system in the second embodiment is the same as the overview shown in FIG. 1. The hardware configuration of portable information device 200 in the second embodiment is the same as the configuration shown in FIG. 5, and a description thereof is not repeated here.

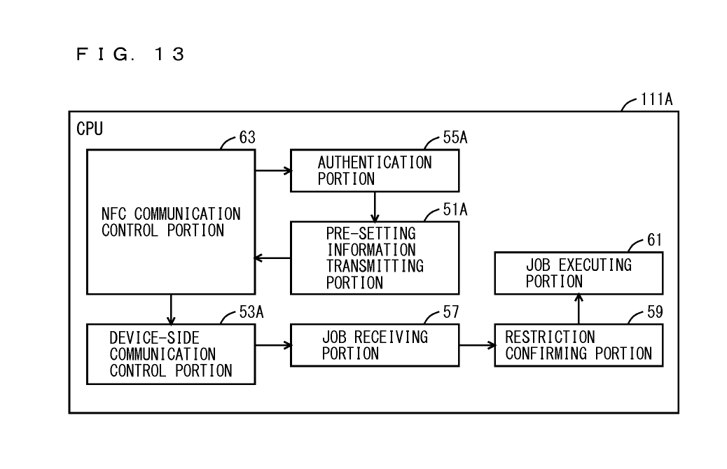

FIG. 11 is a diagram showing an example of the hardware configuration of the MFP in the second embodiment. The hardware configuration shown in FIG. 11 differs from that shown in FIG. 5 in that a first device-side communication unit 117 is added to main circuit 110. The other hardware configuration is the same as in FIG. 5 and a description thereof is not repeated here. First device-side communication unit 117 communicates with portable information device 200 by radio based on the NFC standards. When the distance to portable information device 200 is equal to or smaller than the first distance, first device-side communication unit 117 communicates with portable information device 200. The first distance is, for example, ten and a few centimeters.

First device-side communication unit 117 executes a procedure for communication I/F unit 112 to establish a communication link with portable information device 200 so that communication I/F unit 112 becomes able to communicate with any one of portable information devices 200, 200A. For example, the user brings portable information device 200 closer within the range of the first distance from first device-side communication unit 117, so that communication I/F unit 112 establishes a communication link with portable information device 200. It is determined that the user's operation of brining portable information device 200 closer to MFP 100 is an operation of giving an instruction to establish a communication link between communication I/F unit 112 and portable information device 200, thereby eliminating the need for the user to perform, for example, an operation of designating MFP 100 as a destination in portable information device 200.

Operation panel 160 of MFP 100 in the second embodiment is the same as shown in the plan view in FIG. 4 except for NFC tag 117A. Operation panel 160 of MFP 100 in the second embodiment has a contact position notice region 117C in place of NFC tag 117A. The antenna of first device-side communication unit 117 is arranged in contact position notice region 117C. Contact position notice region 117C is merely a display for notifying the user of the position to which the user may bring portable information device 200.

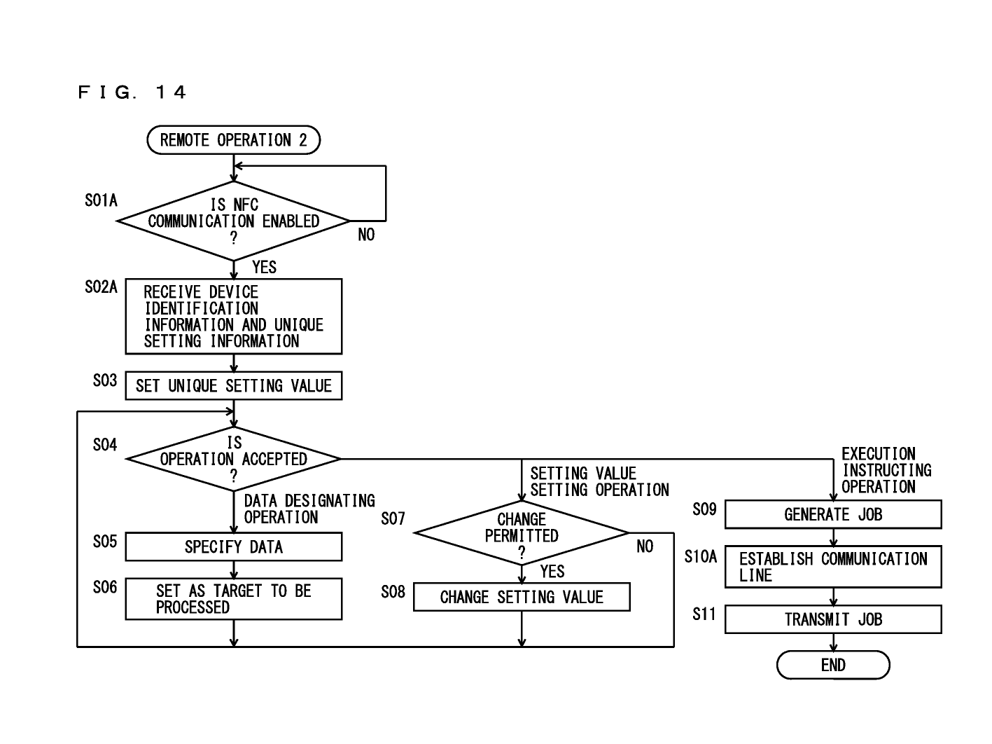

FIG. 12 is a diagram showing exemplary functions of the CPU of the portable information device in the second embodiment. Referring to FIG. 12, the functions differ from those in FIG. 6 in that pre-setting acquiring portion 251 is changed to a pre-setting acquiring portion 251A. The other functions are the same as the functions shown in FIG. 6 and a description thereof is not repeated here.

Pre-setting acquiring portion 251A acquires the device identification information and the unique setting information of MFP 100. Pre-setting acquiring portion 251A includes a reception control portion 261A. Reception control portion 261A controls first portable-side communication unit 209 and receives the device identification information and the unique setting information from first device-side communication unit 117 when first portable-side communication unit 209 becomes able to communicate with first device-side communication unit 117 of MFP 100. In other words, reception control portion 261A receives the device identification information and the unique setting information when portable information device 200 comes close within the first distance from contact position notice region 117C indicated on operation panel 160 of MFP 100. Reception control portion 261A outputs the device identification information of MFP 100 received from MFP 100 to communication control portion 259 and outputs the unique setting information of MFP 100 received from MFP 100 to setting portion 253.

In response to input of the device identification information of MFP 100 from pre-setting acquiring portion 251, communication control portion 259 controls wireless LAN I/F 208 and establishes a communication link with MFP 100 using the device identification information.

In other words, first portable-side communication unit 209 performs pairing with MFP 100 so that wireless LAN I/F 208 can communicate with MFP 100. The user brings portable information device 200 closer within the range of the first distance from contact position notice region 117C indicated on operation panel 160 of MFP 100, so that wireless LAN I/F 208 becomes able to communicate with MFP 100. Wireless LAN I/F 208 may be replaced with an interface for wireless communication based on, for example, the Bluetooth (registered trademark) standards or the IrDA standards.

FIG. 13 is a diagram showing exemplary functions of the CPU of the MFP in the second embodiment. Referring to FIG. 13, the functions differ from those shown in FIG. 7 in that a pre-setting information transmitting portion 51A and an NFC communication control portion 63 are added and that authentication portion 55 is changed to an authentication portion 55A. The other functions are the same as the functions shown in FIG. 7 and a description thereof is not repeated here.

NFC communication control portion 63 controls first device-side communication unit 117 and communicates with portable information device 200 when first device-side communication unit 117 becomes able to communicate with portable information device 200. NFC communication control portion 63 receives the device identification information of portable information device 200 from portable information device 200 that first device-side communication unit 117 becomes able to communicate with, and outputs the received device identification information to authentication portion 55A.

In response to input of the device identification information of portable information device 200, authentication portion 55A authenticates the user who operates portable information device 200. A set of the user identification information of the user authorized to operate MFP 100 and the device identification information of the device allocated to that user is stored in HDD 115. If the device identification information input from NFC communication control portion 63 is stored in HDD 115, authentication portion 55A authenticates the user specified by the user identification information paired with that device identification information and outputs an authentication success signal to pre-setting information transmitting portion 51A.

In response to input of the authentication success signal from authentication portion 55A, pre-setting information transmitting portion 51A outputs a set of the device identification information and the unique setting information of MFP 100 stored in HDD 115 to NFC communication control portion 63.

In response to input of a set of the device identification information and the unique setting information of MFP 100 from pre-setting information transmitting portion 51A, NFC communication control portion 63 transmits a set of the device identification information and the unique setting information of MFP 100 to portable information device 200 and outputs the device identification information of portable information device 200 to device-side communication control portion 53A.

When first device-side communication unit 117 becomes able to communicate with portable information device 200 and the authentication of the user who operates portable information device 200 by authentication portion 55A is successful, device-side communication control portion 53A receives the device identification information of portable information device 200 from NFC communication control portion 63. Device-side communication control portion 53A establishes a communication link with portable information device 200 if the device identification information of portable information device 200 is input from NFC communication control portion 63 and thereafter communication I/F unit 112 receives a connection request from portable information device 200 specified by that device identification information. If a communication link is established with portable information device 200 and thereafter a job is received from portable information device 200 through the communication link, device-side communication control portion 53A outputs the received job to job receiving portion 57.

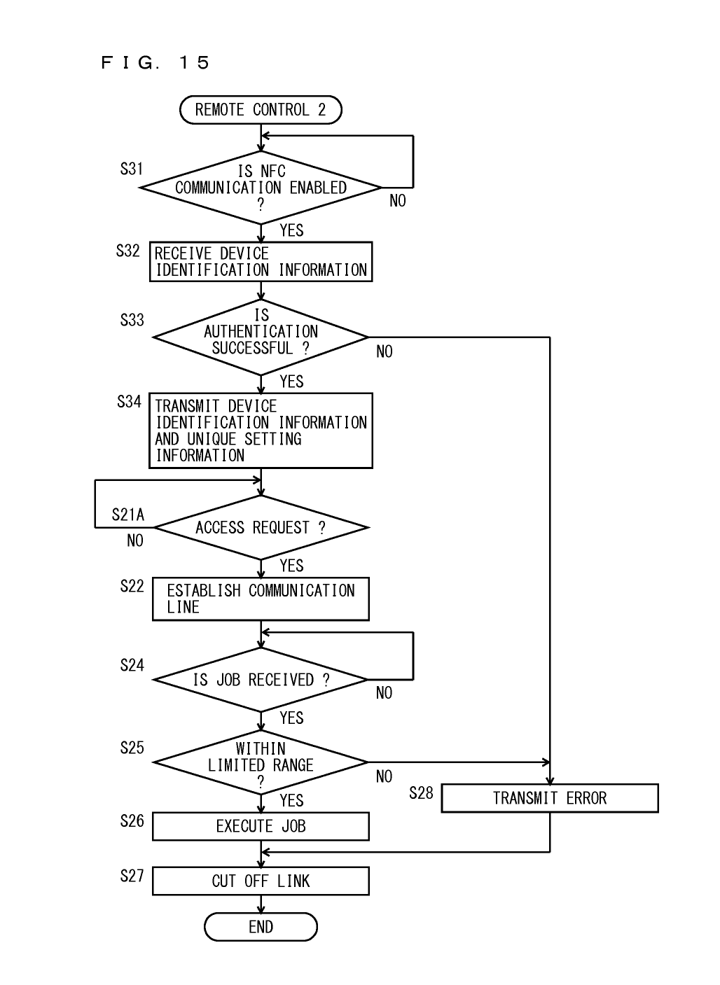

FIG. 14 is a flowchart showing an example of a remote operation process in the second embodiment. Referring to FIG. 14, the remote operation process differs from that shown in FIG. 8 in that step S01, step S02, and step S10 are changed to step S01A, step S02A, and step S10A. The other processing is the same as the processing shown in FIG. 8, and a description thereof is not repeated here.

In step S01A, CPU 201 determines whether communication with first device-side communication unit 117 of MFP 100 based on the NFC standards is enabled (step S01A). The process waits until first portable-side communication unit 209 becomes able to communicate with first device-side communication unit 117 (NO in step S01A). If first portable-side communication unit 209 becomes able to communicate with first device-side communication unit 117 (YES in step S01A), the process proceeds to step S02A. The range over which first portable-side communication unit 209 can communicate is ten and a few centimeters, and when the user brings portable information device 200 closer to contact position notice region 117C of operation panel 160, first portable-side communication unit 209 becomes able to communicate with first device-side communication unit 117.

In step S02A, first portable-side communication unit 209 is controlled such that the device identification information and the unique setting information are received from MFP 100. In step S10A, wireless LAN I/F 208 is controlled such that a communication link is established with MFP 100 specified by the device identification information received in step S02A. The job generated in step S09 is then transmitted using the established communication link (step S11). The process then ends.

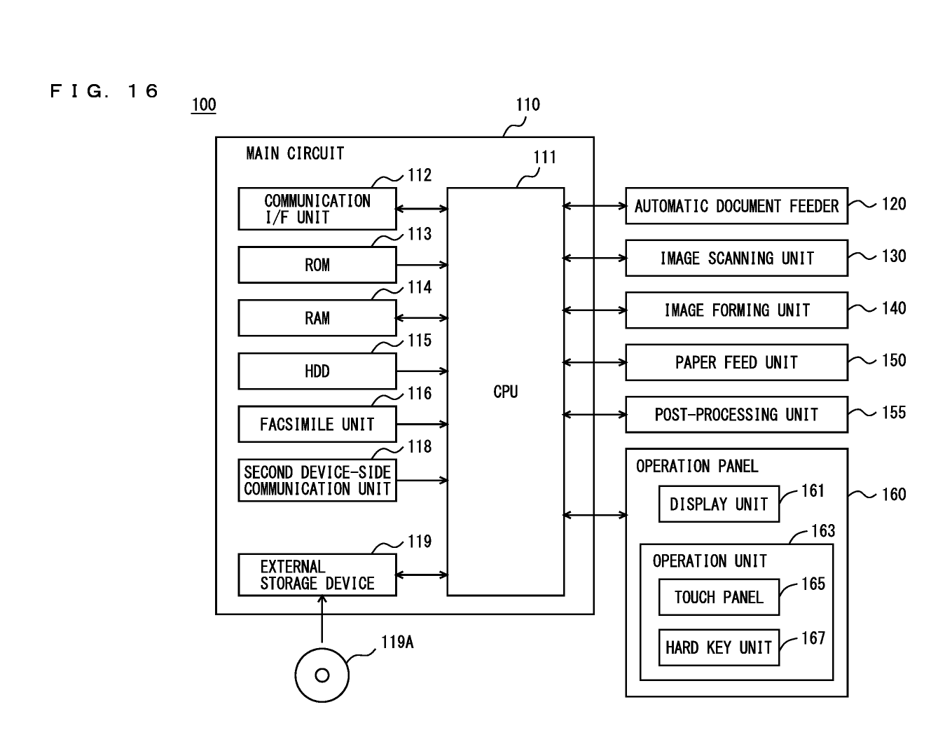

FIG. 15 is a flowchart showing an example of the procedure of a remote control process in the second embodiment. Referring to FIG. 15, the remote control process differs from that shown in FIG. 9 in that step S31 to step S34 are added, that step S21 is changed to step S21A, and that step S23 is deleted. The other processing is the same as the processing shown in FIG. 9 and a description thereof is not repeated here.

CPU 111 determines whether first device-side communication unit 117 becomes able to communicate with portable information device 200 based on the NFC standards, in step S31. The process waits until communication based on the NFC standards is enabled (NO in step S31). If communication is enabled (YES in step S31), the process proceeds to step S32. In step S32, the device identification information of portable information device 200 is received from portable information device 200 with which communication is enabled. The user who operates portable information device 200 is then authenticated using the device identification information (step S33). If authentication is successful, the process proceeds to step S34. If not, the process ends. A set of the user identification information of the user authorized to operate MFP 100 and the device identification information of the device allocated to that user is stored in HDD 115. If the device identification information received from portable information device 200 is stored in HDD 115, the user specified by the user identification information paired with that device identification information is authenticated. If not stored, the user is not authenticated.

In step S34, the device identification information and the unique setting information are transmitted to portable information device 200 through first device-side communication unit 117. The process then proceeds to step S21A.

In step S21A, it is determined whether communication I/F unit 112 receives an access request from portable information device 200 specified by the device identification information received in step S32. The process waits until communication I/F unit 112 receives an access request from portable information device 200 (NO in step S21A). If an access request is received (YES in step S21A), the process proceeds to step S22.

As described above, the image processing system in the second embodiment has the effect as follows, in addition to the effect achieved by the image processing system in the first embodiment. When portable information device 200 comes closer within the range of the first distance from the antenna of NFC tag 117A of MFP 100, first portable-side communication unit 209 becomes able to communicate with MFP 100, receives the device identification information and the unique setting information from MFP 100, controls wireless LAN I/F 208 to establish a communication link with MFP 100, and controls wireless LAN I/F 208 to transmit a job to MFP 100. With the operation of bringing portable information device 200 closer within the first distance from MFP 100, the wireless LAN I/F is controlled to establish a communication link with MFP 100, thereby facilitating the operation of establishing a communication link with MFP 100 for transmitting a job.

### Third Embodiment

In image processing system 1 in the first and second embodiments, portable information device 200 performs communication in accordance with the NFC standards. In image processing system 1 in a third embodiment, portable information device 200 does not perform communication in accordance with the NFC standards. The differences of image processing system 1 in the third embodiment from image processing system 1 in the first embodiment are mainly described below. The overview of the image processing system in the third embodiment is the same as the overview shown in FIG. 1.

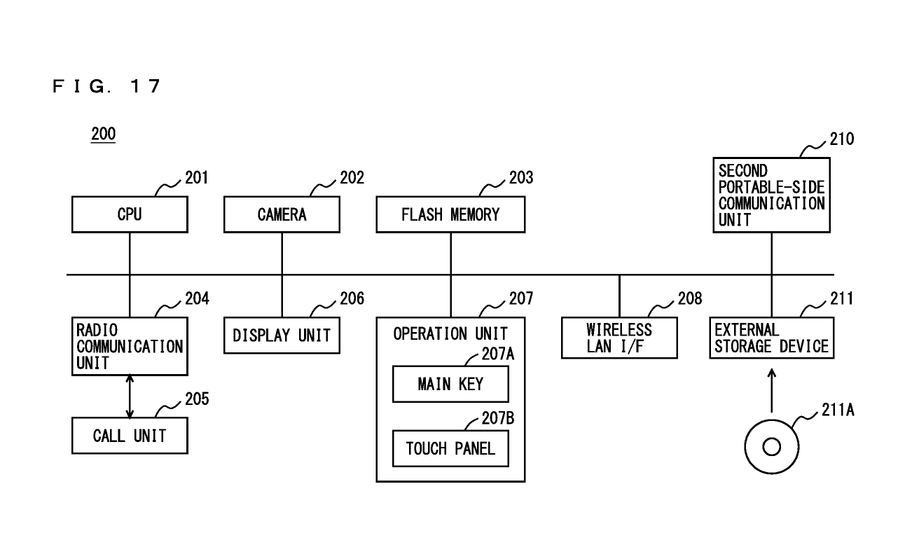

FIG. 16 is a diagram showing an example of the hardware configuration of the MFP in the third embodiment. Referring to FIG. 16, the hardware configuration differs from that shown in FIG. 3 in that a second device-side communication unit 118 is added to main circuit 110. The other hardware configuration is the same as the configuration shown in FIG. 5 and a description thereof is not repeated here. Second device-side communication unit 118 performs communication by radio based on the Bluetooth (registered trademark) standards. The distance over which second device-side communication unit 118 can communicate is a second distance longer than the first distance. The second distance is, for example, 10 meters or longer.

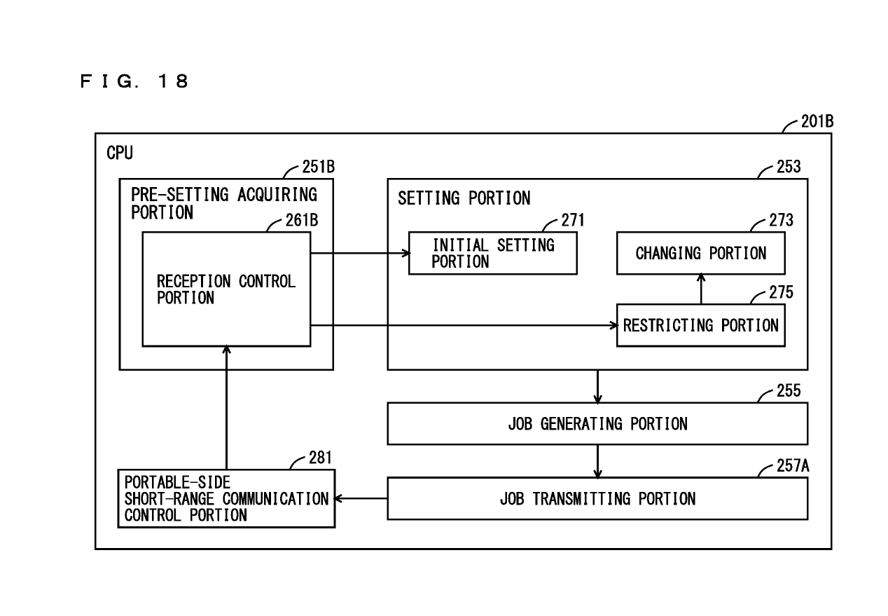

FIG. 17 is a diagram showing an example of the hardware configuration of the portable information device in the third embodiment. Referring to FIG. 17, the hardware configuration differs from that shown in FIG. 5 in that first portable-side communication unit 209 is deleted and that second portable-side communication unit 210 is added. The other hardware configuration is the same as the configuration shown in FIG. 5 and a description thereof is not repeated here. Second portable-side communication unit 210 performs communication by radio based on the Bluetooth (registered trademark) standards.

MFP 100 in the third embodiment detects portable information device 200 and communicates with portable information device 200 if portable information device 200 is present in the range over which second device-side communication unit 118 can communicate. The user carrying portable information device 200 enters the range of the second distance from MFP 100, so that MFP 100 and portable information device 200 starts communication. The second distance is longer than the first distance. The user brings portable information device 200 closer within the range of the second distance from MFP 100, so that second portable-side communication unit 210 becomes able to communicate with MFP 100. Second portable-side communication unit 210 may be an interface for wireless communication based on, for example, the IrDA standards in place of the Bluetooth (registered trademark) standards.

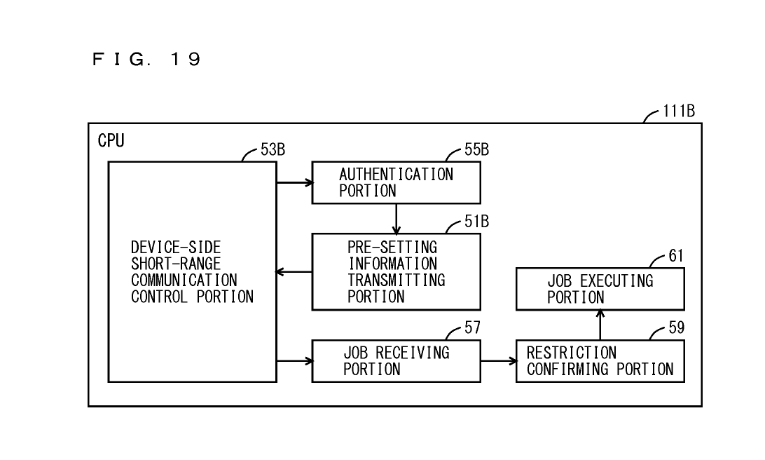

FIG. 18 is a diagram showing exemplary functions of the CPU of the portable information device in the third embodiment. Referring to FIG. 18, the functions differ from those shown in FIG. 6 in that pre-setting acquiring portion 251 is changed to a pre-setting acquiring portion 251B and that a portable-side short-range communication control portion 281 is added. The other functions are the same as the functions shown in FIG. 6 and a description thereof is not repeated here.

Portable-side short-range communication control portion 281 controls second portable-side communication unit 210 and establishes a communication link with MFP 100 when second portable-side communication unit 210 becomes able to communicate with second device-side communication unit 118 of MFP 100. Portable-side short-range communication control portion 281 outputs link identification information for identifying the communication link established with MFP 100 to pre-setting acquiring portion 251B. In other words, portable-side short-range communication control portion 281 establishes a communication link with MFP 100 when portable information device 200 comes closer within the second distance from MFP 100.

Pre-setting acquiring portion 251B acquires the device identification information and the unique setting information of MFP 100. Pre-setting acquiring portion 251B includes a reception control portion 261B. In response to input of the link identification information from portable-side short-range communication control portion 281, reception control portion 261B controls second portable-side communication unit 210 to transmit the device identification information of portable information device 200 through the communication link specified by the link identification information. The operation of MFP 100 receiving the device identification information of portable information device 200 will be described later. If authentication is successful, the device identification information and the unique setting information of MFP 100 are returned. When second portable-side communication unit 210 receives the device identification information and the unique setting information from MFP 100, reception control portion 261B acquires the received device identification information and unique setting information. Reception control portion 261B outputs the received unique setting information of MFP 100 to unique setting value setting portion 271 and restricting portion 275 in setting portion 253.

FIG. 19 is a diagram showing exemplary functions of the CPU of the MFP in the third embodiment. Referring to FIG. 19, the functions differ from those shown in FIG. 7 in that a pre-setting information transmitting portion 51B is added and that device-side communication control portion 53 and authentication portion 55 are changed to a device-side short-range communication control portion 53B and an authentication portion 55B. The other functions are the same as the functions shown in FIG. 7 and a description thereof is not repeated here.

Device-side short-range communication control portion 53B controls second device-side communication unit 118 and communicates with portable information device 200 when second device-side communication unit 118 becomes able to communicate with portable information device 200. Device-side short-range communication control portion 53B receives the device identification information of portable information device 200 from portable information device 200 that second device-side communication unit 118 becomes able to communicate with, and outputs the received device identification information to authentication portion 55B.

In response to input of the device identification information of portable information device 200, authentication portion 55B authenticates the user who operates portable information device 200. A set of the user identification information of the user authorized to operate MFP 100 and the device identification information of the device allocated to that user is stored in HDD 115. If the device identification information input from device-side short-range communication control portion 53B is stored in HDD 115, authentication portion 55B authenticates the user specified by the user identification information paired with that device identification information and outputs an authentication success signal to pre-setting information transmitting portion 51B.

In response to input of the authentication success signal from authentication portion 55B, pre-setting information transmitting portion 51B outputs a set of the device identification information and the unique setting information of MFP 100 stored in HDD 115 to device-side short-range communication control portion 53B.

In response to input of a set of the device identification information and the unique setting information of MFP 100 from pre-setting information transmitting portion 51B, device-side short-range communication control portion 53B transmits a set of the device identification information and the unique setting information of MFP 100 to portable information device 200. Device-side short-range communication control portion 53B transmits a set of the device identification information and the unique setting information of MFP 100 to portable information device 200 if second device-side communication unit 117 becomes able to communicate with portable information device 200 and the authentication of the user who operates portable information device 200 by authentication portion 55B is successful. When a job is received from portable information device 200 after a set of the device identification information and the unique setting information of MFP 100 is transmitted to portable information device 200, device-side short-range communication control portion 53B outputs the received job to job receiving portion 57.

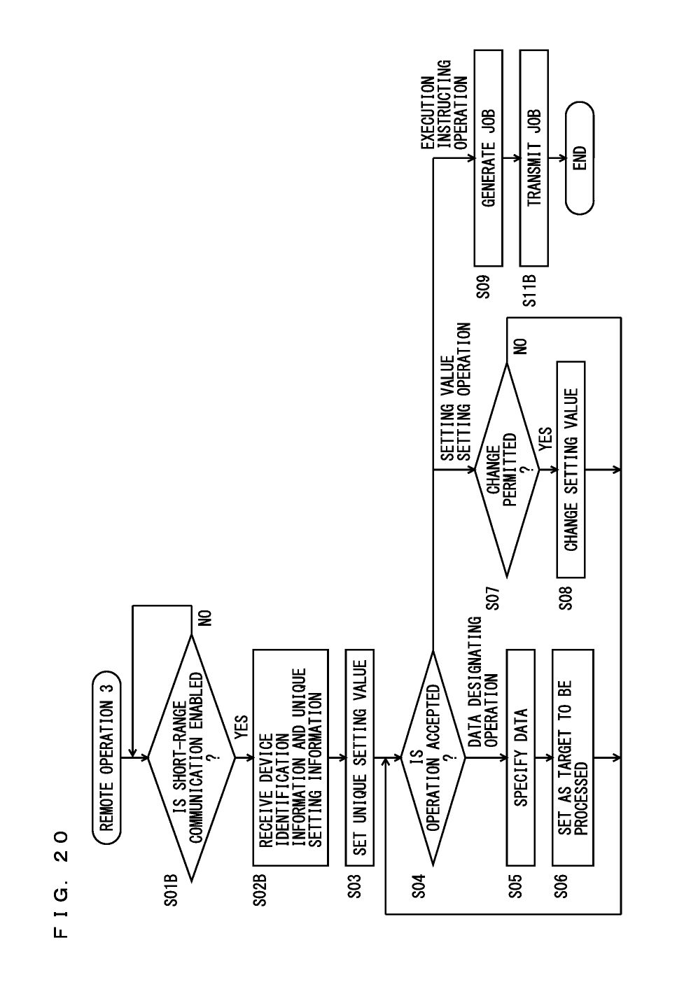

FIG. 20 is a flowchart showing an example of a remote operation process in the third embodiment. Referring to FIG. 20, the remote operation process differs from that in the second embodiment shown in FIG. 14 in that step S01A, step S02A, and step S11 are changed to step S01B, step S02B, and step S11B and that step S10A is deleted. The other processing is the same as the processing shown in FIG. 14 and a description thereof is not repeated here.

In step S01B, CPU 201 determines whether communication with second device-side communication unit 118 of MFP 100 is enabled (step S01B). The process waits until second portable-side communication unit 210 becomes able to communicate with second device-side communication unit 118 (NO in step S01B). If communication with second device-side communication unit 118 is enabled (YES in step S01B), the process proceeds to step S02B. The range over which second portable-side communication unit 210 can communicate is ten and a few meters. Thus, when the user carrying portable information device 200 comes within ten and a few meters from MFP 100, second portable-side communication unit 210 becomes able to communicate with second device-side communication unit 118.

In step S02B, second portable-side communication unit 210 is controlled such that the device identification information and the unique setting information are received from MFP 100. In step S11B, second portable-side communication unit 210 is controlled such that the job generated in step S09 is transmitted to MFP 100 specified by the device identification information received in step S02B. The process then ends.

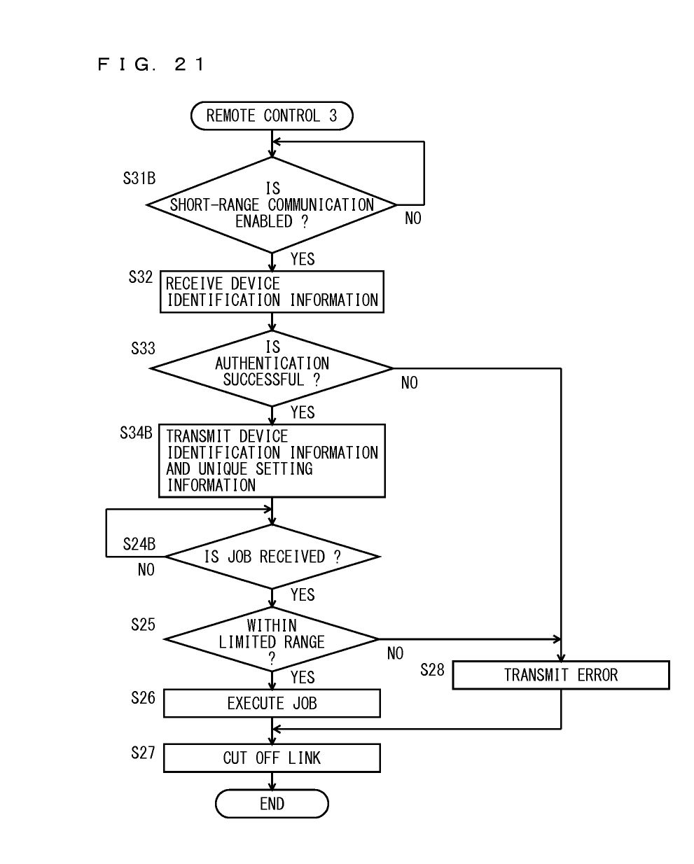

FIG. 21 is a flowchart showing an example of a remote control process in the third embodiment. Referring to FIG. 21, the remote control process differs from that in the second embodiment shown in FIG. 15 in that step S21A and step S22 are deleted and that step S31, step S34, and step S24 are changed to step S31B, step S34B, and step S24B. The other processing is the same as the processing shown in FIG. 9 and a description thereof is not repeated here.

CPU 111 determines whether second device-side communication unit 118 becomes able to perform short-range communication with portable information device 200, in step S31B. The process waits until short-range communication is enabled (NO in step S31B). If short-range communication is enabled (YES in step S31B), the process proceeds to step S32. In step S32, the device identification information of portable information device 200 is received from portable information device 200 with which communication is enabled. The user who operates portable information device 200 is then authenticated using the device identification information (step S33). If authentication is successful, the process proceeds to step S34. If not, the process proceeds to step S28.

In step S34B, the device identification information and the unique setting information are transmitted to portable information device 200 through second device-side communication unit 118. The process then proceeds to step S24B. In step S24B, it is determined whether second device-side communication unit 118 receives a job from MFP 100. The process waits until a job is received (NO in step S24B). If a job is received (YES in step S24B), the process proceeds to step S25.

As described above, in the image processing system in the third embodiment, when coming within a range of a predetermined distance from MFP 100, portable information device 200 establishes a communication link with MFP 100 and receives the device identification information and the unique setting value from MFP 100. Portable information device 200 then sets a unique setting value, generates a job based on the set unique setting value, and transmits the generated job using the established communication link. Thus, with the operation of brining portable information device 200 closer within a range of a predetermined distance from the image forming apparatus, the unique setting value set in MFP 100 can be set in the portable information device, and a job can be transmitted from portable information device 200 to MFP 100.

### Fourth Embodiment

In image processing system 1 in the first and second embodiments, portable information device 200 performs communication in accordance with the NFC standards. In image processing system 1 in a fourth embodiment, portable information device 200 does not perform communication in accordance with the NFC standards. The differences of image processing system 1 in the fourth embodiment from image processing system 1 in the first embodiment are mainly described below. The overview of the image processing system in the fourth embodiment is the same as the overview shown in FIG. 1. The hardware configuration of the MFP in the fourth embodiment is the same as the hardware configuration shown in FIG. 3, and a description thereof is not repeated here.

MFP 100 in the fourth embodiment displays the device identification information and the unique setting information of MFP 100 on display unit 161. Portable information device 200 captures an image of the device identification information and the unique setting information of MFP 100 appearing on display unit 161 with camera 202 and analyzes the obtained image, whereby portable information device 200 acquires the device identification information and the unique setting information of MFP 100.

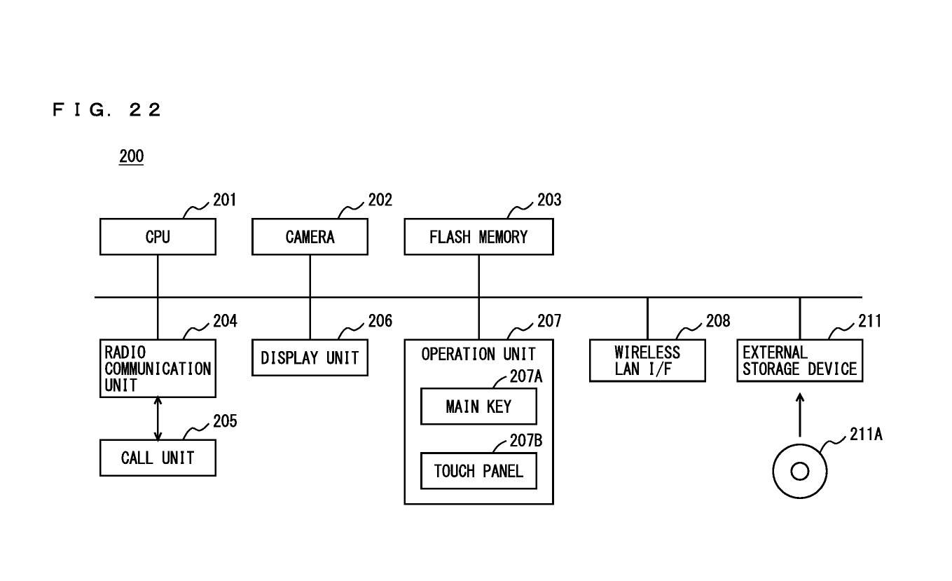

FIG. 22 is a diagram showing an example of the hardware configuration of the portable information device in the fourth embodiment. Referring to FIG. 22, the hardware configuration differs from that shown in FIG. 5 in that first portable-side communication unit 209 is deleted. The other configuration is the same as the configuration shown in FIG. 5 and a description thereof is not repeated here.

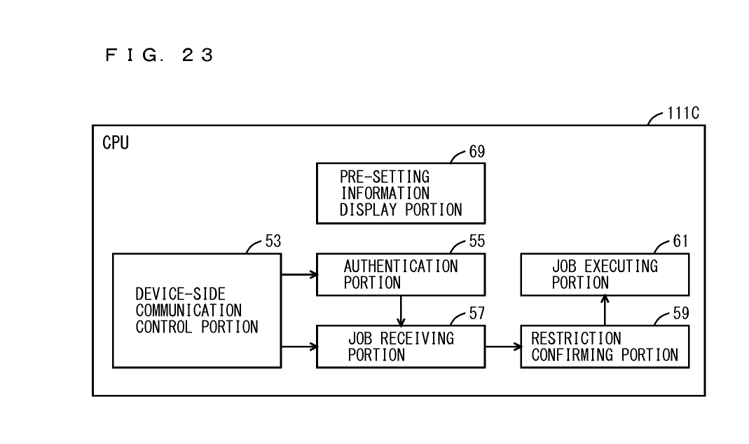

FIG. 23 is a diagram showing exemplary functions of the CPU of the MFP in the fourth embodiment. Referring to FIG. 23, the functions differ from those shown in FIG. 7 in that a pre-setting information display portion 69 is added. The other functions are the same as the functions shown in FIG. 7 and a description thereof is not repeated here.

Pre-setting information display portion 69 displays a two-dimensional bar code, which is the coded device identification information and unique setting information of MFP 100, on display unit 161. Characters representing the device identification information and the unique setting information may be displayed in place of a two-dimensional bar code.

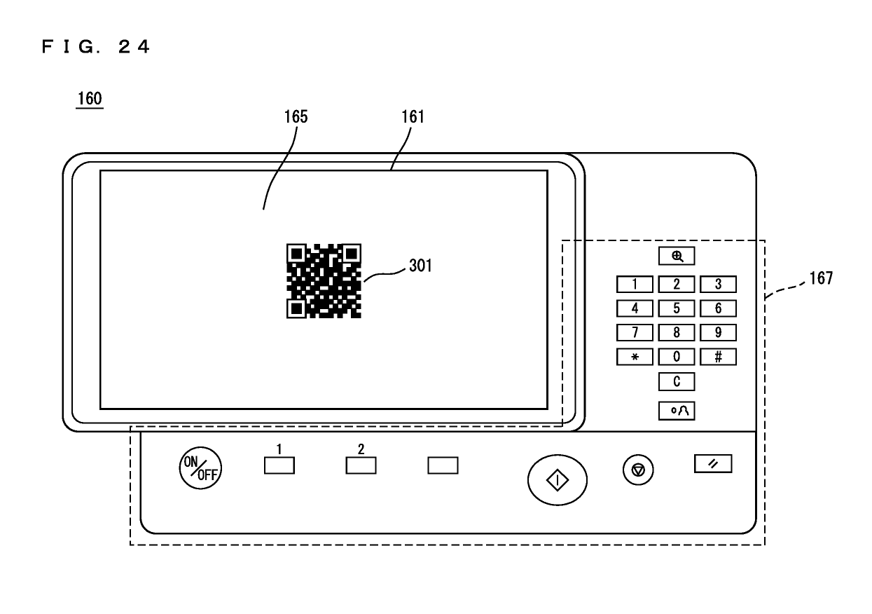

FIG. 24 is a plan view showing an example of the operation panel on which a two-dimensional bar code appears. Referring to FIG. 24, a two-dimensional bar code 301 appears on display unit 161 of operation panel 161. The two-dimensional bar code is, for example, a QR code (registered trademark).

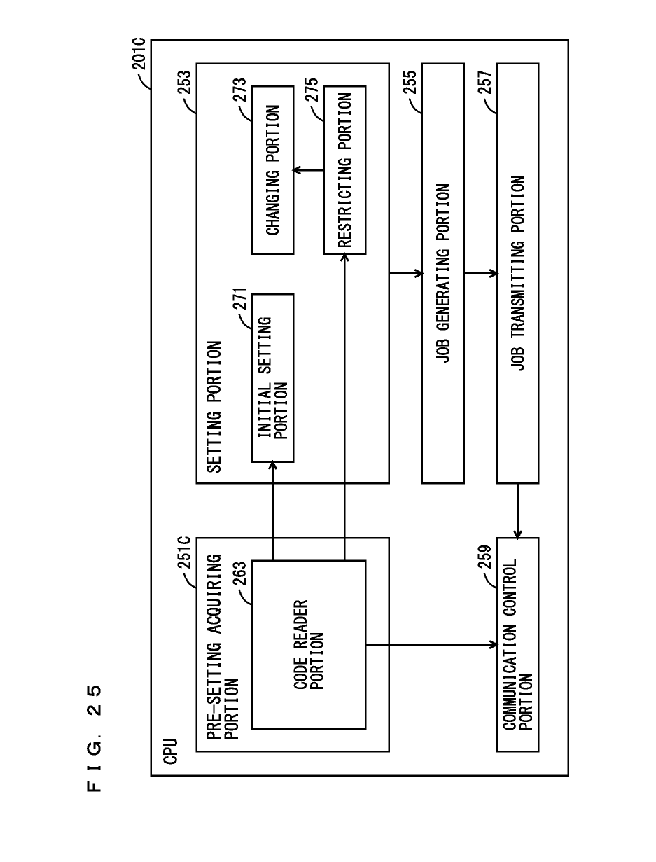

FIG. 25 is a diagram showing exemplary functions of the CPU of the portable information device in the fourth embodiment. Referring to FIG. 25, the functions differ from those shown in FIG. 6 in that pre-setting acquiring portion 251 is changed to a pre-setting acquiring portion 251C. The other functions are the same as the functions shown in FIG. 6 and a description thereof is not repeated here.

Pre-setting acquiring portion 251C acquires the device identification information and the unique setting information of MFP 100. Pre-setting acquiring portion 251C includes a code reader portion 263. Code reader portion 263 controls camera 202 to capture an image of a subject. The subject is determined by the user. When the user sets two-dimensional bar code 301 appearing on display unit 161 of MFP 100 as a subject, camera 202 captures an image of two-dimensional bar code 301, so that code reader portion 263 acquires the image of two-dimensional bar code 301 output by camera 202. Code reader portion 263 analyzes the acquired two-dimensional bar code 301 and acquires the device identification information and the unique setting information of MFP 100. A generally known conventional application program may be used for capturing an image of the two-dimensional bar code with camera 202 and analyzing the obtained image of the two-dimensional bar code. Code reader portion 263 outputs the obtained device identification information of MFP 100 to communication control portion 259 and outputs the unique setting information of MFP 100 to initial setting portion 271 and restricting portion 275 in setting portion 253.

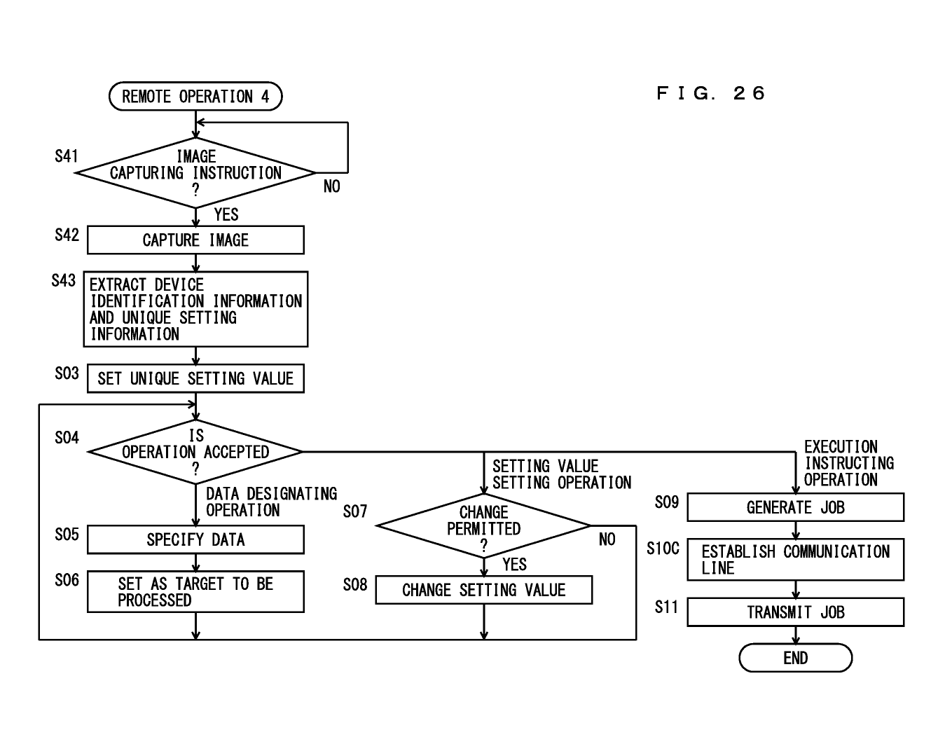

FIG. 26 is a flowchart showing an example of a remote operation process in the fourth embodiment. Referring to FIG. 26, the remote operation process differs from that in the first embodiment shown in FIG. 8 in that step S41 to step S43 are added in place of step S01 and step S02 and that step S10 is changed to step S10C. The other processing is the same as the processing shown in FIG. 8 and a description thereof is not repeated here.

In step S41, CPU 201 determines whether an instruction to capture an image is accepted from the user. The process waits until an instruction to capture an image is accepted (NO in step S41). If an instruction to capture an image is accepted (YES in step S41), the process proceeds to step S42. In step S42, camera 202 is controlled such that an image of a subject is captured. If the user sets the two-dimensional bar code appearing on display unit 161 of MFP 100 as a subject, camera 202 captures an image of the two-dimensional bar code. The image of the two-dimensional bar code output by camera 202 is thus acquired. In step S43, the image obtained through image capturing is analyzed, and the device identification information and the unique setting information of MFP 100 are acquired. The process then proceeds to step S03.

The remote control process executed by MFP 100 in the fourth embodiment is the same as the remote control process in the first embodiment shown in FIG. 9 and a description thereof is not repeated here.

As described above, in the image processing system in the fourth embodiment, portable information device 200 captures an image of a two-dimensional bar code appearing on display unit 161 of MFP 100 with camera 202 and analyzes the two-dimensional bar code obtained through image capturing, thereby acquiring the device identification information and the unique setting information of MFP 100. Thus, with a simple operation of capturing an image of a two-dimensional bar code appearing on display unit 161 of MFP 100 with camera 202, the user who operates portable information device 200 can set the unique setting value set in MFP 100 in portable information device 200 and set MFP 100 as a job destination.

Although portable information device 200 has been described in the foregoing embodiments, it is needless to say that the present invention can be understood as a remote operation method that allows portable information device 200 to execute the remote operation process shown in FIG. 8, FIG. 14, FIG. 20, or FIG. 26 and a remote operation program that allows CPU 201 of portable information device 200 to execute the remote operation method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A portable information device comprising a controller,
the controller executing:
a pre-setting acquisition step of acquiring device identification information for identifying an image processing apparatus to execute a job and a unique setting value that is a setting value preset in the image processing apparatus;
a setting step of setting a setting value;
a job generation step of generating a job based on the set setting value; and
a job transmission step of transmitting the generated job to the image processing apparatus specified by the device identification information acquired in the pre-setting acquisition step,
the setting step including an initial setting step of setting the acquired unique setting value in response to the unique setting value being acquired in the pre-setting acquisition step.

2. The portable information device according to claim 1, wherein
the controller further executes a setting screen display step of displaying a setting screen for accepting input of a setting value on a display unit, and
the setting screen display step includes a step of displaying the setting screen after the unique setting value is set in the initial setting step.

3. The portable information device according to claim 1, further comprising a first communication portion capable of communication within a range of a predetermined distance,
wherein the pre-setting acquisition step includes a reception control step of controlling the first communication portion to receive the device identification information and the unique setting value from an NFC tag that stores the device identification information and the unique setting value of the image processing apparatus to execute a job, in response to the first communication portion becoming able to communicate with the NFC tag.

4. The portable information device according to claim 3, further comprising a second communication portion different from the first communication portion, wherein
the controller further executes a communication control step of controlling the second communication portion to establish a communication link with the image processing apparatus using the device identification information acquired in the pre-setting acquisition step, and
the job transmission step includes a step of transmitting the job using the communication link established in the communication control step.

5. The portable information device according to claim 1, further comprising:
a first communication portion capable of communication within a range of a predetermined distance; and
a second communication portion different from the first communication portion, wherein
the controller further executes a communication control step of controlling the second communication portion to establish a communication link with the image processing apparatus, using the device identification information acquired in the pre-setting acquisition step,
the pre-setting acquisition step includes a reception control step of controlling the first communication portion to receive the device identification information and the unique setting value from the image processing apparatus, in response to the first communication portion becoming able to communicate with the image processing apparatus, and
the job transmission step includes a step of transmitting the job using the communication link established in the communication control step.

6. The portable information device according to claim 1, further comprising a short-range communication portion capable of communication within a range of a predetermined distance, wherein
the controller further executes a short-range communication control step of controlling the short-range communication portion to establish a communication link with the image processing apparatus, in response to the short-range communication portion becoming able to communicate with an image processing apparatus to execute a job,
the pre-setting acquisition step includes a reception control step of receiving the device identification information and the unique setting value of the image processing apparatus from the image processing apparatus that the short-range communication portion becomes able to communicate with, using the communication link established in the short-range communication control step, and
the job transmission step includes a step of transmitting the job using the same communication link as the communication link used in the reception control step.

7. The portable information device according to claim 1, further comprising a code reader to read a two-dimensional bar code displayed by the image processing apparatus to execute a job,
wherein the pre-setting acquisition step includes a step of acquiring the device identification information and the unique setting value of the image processing apparatus, based on the two-dimensional bar code read by the code reader.

8. The portable information device according to claim 1, wherein
the pre-setting acquisition step includes a step of acquiring restriction information that defines that a setting value cannot be changed, in addition to the device identification information and the unique setting value, and
the setting step further includes a restriction step of, if the restriction information is acquired in the pre-setting acquisition step, restricting a change to the unique setting value after the unique setting value is set in the initial setting step.

9. An image processing system comprising an image processing apparatus that executes a job and a remote control device that remotely controls the image processing apparatus,
the image processing apparatus comprising:
a first device-side communication portion capable of communication within a range of a predetermined distance;
a storage portion to store device identification information for identifying the image processing apparatus and a unique setting value that is a setting value preset in the image processing apparatus;
a device-side transmission portion configured to control the first device-side communication portion to transmit the stored device identification information and unique setting value to the remote control device, in response to the first device-side communication portion becoming able to communicate with the remote control device;
a second device-side communication portion different from the first device-side communication portion; and
a job executing portion configured to, if the second device-side communication portion receives a job from the remote control device, execute the received job,
the remote control device comprising:
a setting portion configured to set a setting value;
a job generating portion configured to generate a job based on the set setting value;
a first communication portion capable of communicating with the first device-side communication portion;
a second communication portion different from the first communication portion;
a reception control portion configured to control the first communication portion to receive the device identification information and the unique setting value from the image processing apparatus, in response to the first communication portion becoming able to communicate with the first device-side communication portion;
a communication control portion configured to control the second communication portion to establish a communication link with the image processing apparatus, using the device identification information acquired by the reception control portion; and
a job transmitting portion configured to transmit the generated job using the communication link established by the communication control portion,
the setting portion including an initial setting portion configured to set the acquired unique setting value, in response to the unique setting value being received by the reception control portion.

10. A remote operation method that allows a portable information device to execute:
a pre-setting acquisition step of acquiring device identification information for identifying an image processing apparatus to execute a job and a unique setting value that is a setting value preset in the image processing apparatus;
a setting step of setting a setting value;
a job generation step of generating a job based on the set setting value; and
a job transmission step of transmitting the generated job to the image processing apparatus specified by the device identification information acquired in the pre-setting acquisition step,
the setting step including an initial setting step of setting the acquired unique setting value, in response to the unique setting value being acquired in the pre-setting acquisition step.

11. A non-transitory computer-readable recording medium encoded with a remote operation program that allows a computer controlling a portable information device to execute:
a pre-setting acquisition step of acquiring device identification information for identifying an image processing apparatus to execute a job and a unique setting value that is a setting value preset in the image processing apparatus;
a setting step of setting a setting value;
a job generation step of generating a job based on the set setting value; and
a job transmission step of transmitting the generated job to the image processing apparatus specified by the device identification information acquired in the pre-setting acquisition step,
the setting step including an initial setting step of setting the acquired unique setting value, in response to the unique setting value being acquired in the pre-setting acquisition step.

12. The non-transitory computer-readable recording medium encoded with a remote operation program according to claim 11, the program further allowing the computer to execute a setting screen display step of displaying a setting screen for accepting input of a setting value,
wherein the setting screen display step includes a step of displaying the setting screen after the unique setting value is set in the initial setting step.

13. The non-transitory computer-readable recording medium encoded with a remote operation program according to claim 10, wherein
the portable information device further comprises a first communication portion capable of communication within a range of a predetermined distance, and
the pre-setting acquisition step includes a reception control step of controlling the first communication portion to receive the device identification information and the unique setting value from an NFC tag that stores the device identification information and the unique setting value of the image processing apparatus to execute a job, in response to the first communication portion becoming able to communicate with the NFC tag.

14. The non-transitory computer-readable recording medium encoded with a remote operation program according to claim 13, wherein
the portable information device comprises a second communication portion different from the first communication portion,
the program further allows the computer to execute a communication control step of controlling the second communication portion to establish a communication link with the image processing apparatus, using the device identification information acquired in the pre-setting acquisition step, and
the job transmission step includes a step of transmitting the job using the communication link established in the communication control step.

15. The non-transitory computer-readable recording medium encoded with a remote operation program according to claim 11, wherein
the portable information device comprises
a first communication portion capable of communication within a range of a predetermined distance, and
a second communication portion different from the first communication portion,
the program further allows the computer to execute a communication control step of controlling the second communication portion to establish a communication link with the image processing apparatus using the device identification information acquired in the pre-setting acquisition step,
the pre-setting acquisition step includes a reception control step of controlling the first communication portion to receive the device identification information and the unique setting value from the image processing apparatus, in response to the first communication portion becoming able to communicate with the image processing apparatus, and
the job transmission step includes a step of transmitting the job using the communication link established in the communication control step.

16. The non-transitory computer-readable recording medium encoded with a remote operation program according to claim 11, wherein
the portable information device comprises a short-range communication portion capable of communication within a range of a predetermined distance,
the program further allows the computer to execute a short-range communication control step of controlling the short-range communication portion to establish a communication link with the image processing apparatus, in response to the short-range communication portion becoming able to communicate with the image processing apparatus to execute a job,
the pre-setting acquisition step includes a reception control step of receiving the device identification information and the unique setting value of the image processing apparatus from the image processing apparatus that the short-range communication portion becomes able to communicate with, using the communication link established in the short-range communication control step, and
the job transmission step includes a step of transmitting the job using the same communication link as the communication link used in the reception control step.

17. The non-transitory computer-readable recording medium encoded with a remote operation program according to claim 11, wherein
the portable information device further comprises a code reader to read a two-dimensional bar code displayed by an image processing apparatus to execute a job, and
the pre-setting acquisition step includes a step of acquiring the device identification information and the unique setting value of the image processing apparatus, based on the two-dimensional bar code read by the code reader.

18. The non-transitory computer-readable recording medium encoded with a remote operation program according to claim 11, wherein
the pre-setting acquisition step includes a step of acquiring restriction information that defines that a setting value cannot be changed, in addition to the device identification information and the unique setting value, and
the setting step further includes a restriction step of, if the restriction information is acquired in the pre-setting acquisition step, restricting a change to the unique setting value after the unique setting value is set in the initial setting step.
